(19) United States
(12) Patent Application Publication
(10) Pub. No.: US 2025/0292759 A1
(43) Pub. Date: Sep. 18, 2025

(54) NAME-DETECTION BASED ATTENTION HANDLING IN ACTIVE NOISE CONTROL SYSTEMS BASED ON AUTOMATED ACOUSTIC SEGMENTATION

(71) Applicant: Google LLC, Mountain View, CA (US)

(72) Inventors: Senthil Mani, Telangana (IN); Nathan Mani, Telangana (IN)

(73) Assignee: Google LLC, Mountain View, CA (US)

(21) Appl. No.: 19/081,871

(22) Filed: Mar. 17, 2025

(30) Foreign Application Priority Data
Mar. 18, 2024 (IN) 202441019923

(51) Int. Cl. G10K 11/178; G10L 15/04; G10L 15/06; G10L 15/16

(52) U.S. Cl. CPC G10K 11/17827; G10K 11/17823; G10K 11/17825; G10K 11/17881; G10K 11/17885; G10L 15/04; G10L 15/063; G10L 15/16; G10K 2210/1081; G10K 2210/3016; G10K 2210/3026; G10K 2210/3027; G10K 2210/3038

(57) ABSTRACT

Automated attention handling techniques are described herein for use with wearable audio components with active noise control (ANC) to suppress ambient sound. A name embedding model is trained automatically to convert name audio samples into acoustic segments based on a knowledge distillation model. The name embedding model is used to generate reference embeddings for each of a user-enrolled set of names, and a relation network and a false rejection network are also trained. In real-time operation, the name embedding model converts real-time audio samples to real-time embeddings, the relation network compared the real-time embeddings to the reference embeddings to look for candidate matches, and the false rejection network validates the candidate matches to detect when one of the user-enrolled names has been invoked. Detecting such an invocation automatically triggers the ANC to switch to a conversation mode.

### CROSS REFERENCE TO RELATED APPLICATIONS

This application claims the benefit of, and priority to Indian Provisional Application No. 20/244,1019923, filed on Mar. 18, 2024, entitled “NAME-DETECTION BASED ATTENTION HANDLING IN ACTIVE NOISE CONTROL SYSTEMS BASED ON AUTOMATED ACOUSTIC SEGMENTATION,” the disclosure of which is hereby incorporated by reference in its entirety for all purposes.

This application is related to PCT Application No. PCT/US2024/034673, filed Jun. 20, 2024, the disclosure of which is hereby incorporated by reference in its entirety for all purposes.

### BACKGROUND

Active noise control (ANC) is a common feature of headsets and earbuds. It operates by generating an anti-noise signal via a speaker that is approximately equal in magnitude, but opposite in phase to the ambient sound (e.g., ambient noise and other sounds in the vicinity). The ambient sound and anti-noise signal cancel each other acoustically, allowing the user to hear only a desired audio signal. Typically, signal processing in ANC includes two paths: an ambient sound signal from a reference microphone is taken as the input of a feed-forward ANC filter (FFANC); and an error microphone signal is taken as the input of a feedback ANC filter (FBANC).

When a user is listening to music or other desired audio through a wearable audio component (e.g., earbuds or on-ear headphones), ANC works to suppress any ambient sound. However, in some instances, ambient sound that is intended for the user can be very important to the user's connectivity with others. For example, while a user is listening to music with ANC, it may be very difficult for an attention seeker to get the user's attention, such as to alert the user of something important and/or to engage the user in a desired conversation. Conventionally, in such instances, the attention seeker gets the user's attention by tapping the user on the shoulder, gesturing in front of the user's face, or the like; and the user can then manually disable the ANC, pause the desired audio, and/or remove the wearable audio component.

### SUMMARY

Systems and methods are described herein for automated attention handling based on automated acoustic segmentation. Embodiments operate in the context of a user wearing a wearable audio component (e.g., in-car headphones, on-ear headphones, etc.) and having active noise control (ANC) turned on to suppress ambient sound. Various novel techniques are described for detecting that an attention seeker is trying audibly to get the attention of the user and for automatically switching the ANC into a conversation mode in response to such detection. For example, a name embedding model is trained automatically to convert name audio samples into acoustic segments based on a knowledge distillation model. The name embedding model is used to generate reference embeddings for each of a user-enrolled set of names, and a relation network and a false rejection network are also trained. In real-time operation, the name embedding model converts real-time audio samples to real-time embeddings, the relation network compared the real-time embeddings to the reference embeddings to look for candidate matches, and the false rejection network validates the candidate matches to detect when one of the user-enrolled names has been invoked. Detecting such an invocation automatically triggers the ANC to switch to a conversation mode.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows an audio management system for integration in a wearable audio component (WAC), according to embodiments described herein.

FIG. 2 shows a conceptual circuit block diagram of a partial audio management system environment with an automated attention handling system (AHS).

FIGS. 3A and 3B show a wearable audio environment including a pair of WACs.

FIG. 4 shows a simplified block diagram of stages of an illustrative implementation of an attention seeker (AS) trigger detection block and the association of each stage with a corresponding portion of a generated inference model, according to embodiments described herein.

FIG. 5 shows a training environment for implementing a first phase of training the knowledge distillation model (KDM).

FIG. 6 shows an example of a posterior probability matrix (PPM) represented as a J×K matrix (i.e., with J*K cells).

FIG. 7 shows a training environment for implementing a second phase of training the KDM.

FIG. 8 shows an illustrative candidate segmentation and an illustrative corresponding PPM and ordered acoustical segmentation vector (OASV).

FIGS. 9A and 9B show example OASVs resulting from an illustrative automated ortho- segmentation and an illustrative re-segmentation, respectively.

FIGS. 10A and 10B show block diagrams of illustrative uses of the name embedding model to generate the deep image.

FIG. 11 shows several example screenshots from an example enrollment application running on a user device.

FIG. 12 shows a flow diagram of an illustrative method for audio management that includes automated attention handling in a WAC, according to embodiments described herein.

FIG. 13 shows a flow diagram of an illustrative method for an enrollment phase.

FIG. 14 shows a flow diagram of an illustrative method for conversation end detection.

FIG. 15 shows a flow diagram of an illustrative method for training an automated acoustic segmentation (AAS) system for use with embodiments described herein.

FIG. 16 shows a flow diagram of an illustrative method for automated acoustic segmentation-based attention handling in a WAC, according to embodiments described herein.

FIG. 17 provides a schematic illustration of an illustrative computational system that can implement various system components and/or perform various steps of methods provided by various embodiments.

### DETAILED DESCRIPTION

When a user is listening to music or other desired audio through a wearable audio component (e.g., earbuds or on-ear headphones), active noise control (ANC) works to suppress any ambient sound. However, in some instances, ambient sound that is intended for the user can be very important to the user's connectivity with others. For example, although the user desired to suppress undesirable ambient sound, the user may still desire to be able on occasion to enter into desired conversations. In general, two types of desired conversation can be considered: first-party-initiated; and second-party-initiated.

In first-party-initiated conversations, the user desires to start a conversation and may begin by trying to get someone's attention. In such cases, some conventional ANC systems are adapted to detect that the user has begun speaking (e.g., by detecting the user's speech via a beamforming microphone directed to the user's mouth, accelerometer, or combination thereof), and the ANC system can turn off, switch to transparency mode, pause audio playback, etc. in response to detecting the user's speaking. Because it tends to be relatively easy for the ANC system to distinguish the user's own speech from ambient sound, such approaches tend to be effective for first-party-initiated conversations.

In second-party-initiated conversations, however, a second-party attention seeker is trying to get the user's attention, and the attention seeker's voice may be difficult to distinguish from other ambient sound. For example, while a user is listening to music with ANC, it may be very difficult for an attention seeker to get the user's attention, such as to alert the user of something important and/or to engage the user in a desired conversation. Conventionally, in such instances, the attention seeker gets the user's attention by tapping the user on the shoulder, gesturing in front of the user's face, or the like. Before the user can participate in the conversation, the user conventionally must notice the interruption and then manually disable the ANC, pause the desired audio, remove the wearable audio component, etc.

Indeed, many users of wearable audio components enjoy the feeling of being in their “bubble” and the ability to focus on their media that comes with effective ANC. However, as ANC continues to improve, the same users often feel increasingly unaware, not present, and fearful about missing out. Embodiments described herein seek to provide users with the ability to better stay aware and engage in desired conversations, while being able to continue wearing their wearable audio components and otherwise to take advantage of ANC. This can provide several benefits, including helping to improve user comfort and car health.

Embodiments described herein are concerned with second-party-initiated conversations. As used herein, the term “user” refers to a wearer of a wearable audio component (i.e., the first party). The term “attention seeker” is used herein generally to refer to any ambient party trying to get the user's attention while the user is wearing the wearable audio component (and presumably is listening to desired audio with ANC turned on). Typically, the attention seeker is a person. However, the attention seeker can also be a computational platform with a deterministic manner of seeking the user's attention, such as a smart speaker programmed to call out the user's name. The term “wearable audio component,” or “WAC” is used herein to generally refer to earbuds, on- car headphones, over-ear headphones, or any type of wearable audio output device that includes ANC. The term “desired audio” is used herein to generally refer to any recorded or streaming audio signal that is being played to the user through the WAC, such as music, an audiobook, a podcast, a radio broadcast, a live event broadcast, etc. The term “ambient sound,” or “ambient audio” is used herein to generally refer to any audio in the vicinity of the WAC, other than the desired audio. It is generally the goal of the ANC system to suppress as much of the ambient sound as possible. Audio originating from an attention seeker while a user's ANC system is active is part of the ambient sound.

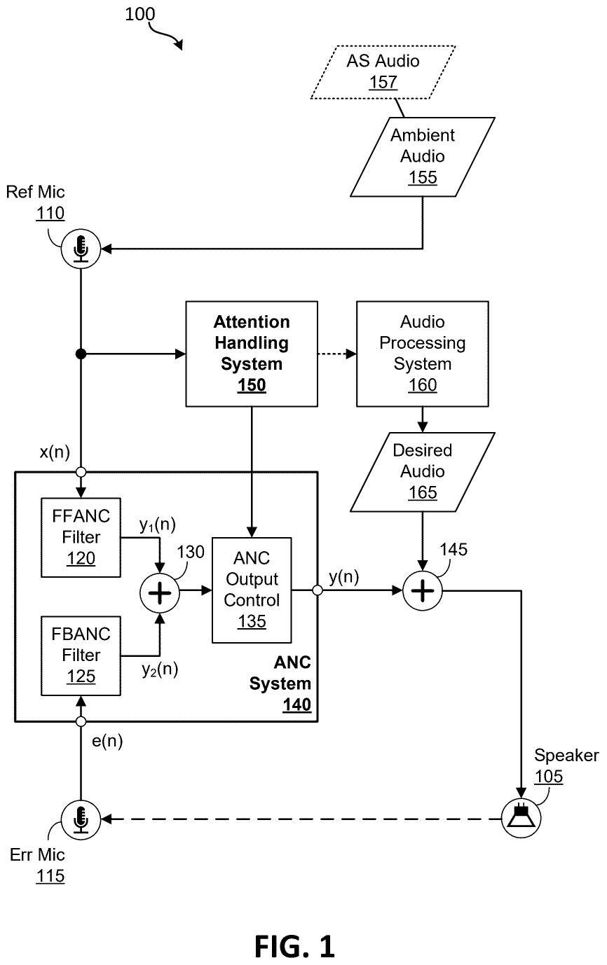

FIG. 1 shows an audio management system 100 for integration in a wearable audio component (WAC), according to embodiments described herein. As illustrated, the audio management system 100 can include an active noise control (ANC) system 140, an attention handling system (AHS) 150, and an audio processing system 160. In general, the purpose of the WAC is to deliver desired audio 165 to a user's ear or ears via one or more ear speakers, such as speaker 105. Embodiments of the audio processing system 160 are designed to process the desired audio 165 for output to the user. For example, the audio processing system 160 can include amplifiers, filters, and/or other audio components; and/or any other suitable components for receiving, processing, and/or outputting the desired audio 165.

Typically, while listening to the desired audio 165, the user is also in presence of ambient audio 155. When in its ambient sound suppression mode, the ANC system 140 seeks to suppress as much of the ambient audio 155 as possible to enhance the user's experience of listening to the desired audio 165. As illustrated, the ANC system 140 includes a feed-forward ANC (FFANC) filter 120, a feedback ANC (FBANC) filter 125, a summer 130, and an ANC output control block 135. The ANC system 140 is also coupled with the speaker 105 and at least a reference microphone 110 and an error microphone 115. Embodiments of the speaker 105 generally convert an electrical audio signal into sound waves that are delivered to the car of the wearer of the wearable audio component. Embodiments of the reference microphone 110 can be an omnidirectional microphone typically integrated with an outer casing of the wearable audio component. The reference microphone 110 generally captures at least the ambient audio 155 around the WAC, which is delivered as a reference audio signal (illustrated as x(n)) to the FFANC filter 120. Embodiments of the error microphone 115 are typically integrated with the inner casing of the wearable audio component to be positioned inside the car canal or very close to it when the wearable audio component is being worn. The error microphone 115 captures the audio that reaches the eardrum, which includes the desired audio signal and any remaining ambient sound after suppression. The error microphone 115 outputs an error signal (illustrated as e(n)) to the FBANC filter 125.

The illustrated ANC system 100 includes a feed-forward noise control path and a feedback noise control path. The feed-forward noise control path includes the FFANC filter 120, which is a digital or analog filter designed to process the audio signal from the reference microphone 110. The FFANC filter 120 applies a specific frequency response to x(n) to adaptively cancel out noise. The specific frequency response is produced by continuously adjusting coefficients of the FFANC filter 120 to minimize the difference between the desired audio signal and the reference signal. The output of the FFANC filter 120 is illustrated as y₁(n). The feedback noise control path includes the FBANC filter 125, which is a digital or analog filter designed to process the audio signal from the error microphone 115. The FBANC filter 125 applies a specific frequency response to e(n) and continuously adjusts coefficients of the FBANC filter 125 to minimize the difference between the desired audio signal and remaining ambient sound in the signal that reaches the eardrum. The output of the FFANC filter 120 is illustrated as y₂(n). In general, both the FFANC filter 120 and the FBANC filter 125 can adapt their respective filters (e.g., their coefficients) in real-time to a changing audio environment. For example, filter coefficients are iteratively adjusted using least mean squares (LMS), normalized LMS (NLMS), and/or other suitable adaptation algorithms.

Embodiments of the summer 130 combine the filtered output signals from the FFANC filter 120 and the FBANC filter 125. For example, the summer 130 calculates a sum of these signals. If tuned properly, the output of the summer 130 is an “anti-noise” signal that closely represents the ambient sound at opposite polarity. Embodiments of the ANC output control block 135 control how and/or whether the anti-noise signal is output by ANC system 140. In some implementations, the ANC output control block 135 includes an amplifier to provide a controllable amount of gain (G) to the signal at the output of the summer 130, resulting in an output signal, y(n)=G(y₁(n)+y₂(n)). In effect, the ANC gain block 135 adjusts the overall amplitude (i.e., corresponding to volume) of the combined filtered signal at the output of the summer 130. The output signal is sent to the speaker 105. In some implementations, as illustrated, the desired audio 165 can also be mixed in (e.g., by mixer 145) prior to sending the output to the speaker 105, such that what reaches the eardrum is almost entirely the desired audio signal with minimal ambient sound. Alternatively, the desired audio 165 is mixed into the output signal at the summer 130, such that the output of the ANC system 140 is an audio signal that is mostly the desired audio 165 with minimal residual ambient audio 155.

Embodiments of the ANC output control block 135 control the operating mode of the ANC system 140. For example, as described herein, the ANC system 140 can operate selectively in at least an active mode (i.e., an ambient sound suppression mode) or a conversation mode. Some implementations of the conversation mode correspond to an inactive mode (i.e., the ANC system 140 is turned off) or a transparency mode. Other implementations of the conversation mode are configured to pass through conversationally relevant audio from the ambient audio 155, while continuing to perform ANC functions to suppress other portions of the ambient audio 155. In some such implementations, a bandpass or notch filter is used to segregate out a range of frequencies typical for human speech and to treat the segregated audio as conversationally relevant audio. As one example, a filter can pass through portions of the ambient audio 155 only in the range of 75 to 300 Hertz and to suppress higher and lower frequency components of the ambient audio 155; thereby continuing to filter out white noise and other portions of ambient audio 155 that can interfere with a user's ability to hear the passed-through conversationally relevant audio. Similarly, some implementations continue to pass through some desired audio 165 (e.g., at a reduced volume) while in conversation mode.

As described herein, embodiments of the AHS system 150 seek to detect when a second- party attention seeker is trying to get the attention of a user while the user is wearing the WAC and is listening to desired audio 165 with the ANC system 140 in the active mode. In particular, the AHS system 150 listens for presence of attention seeking (AS) audio 157 within the ambient audio 155. Various techniques can be used by AHS systems 150 to detect presence of such AS audio 157 within the ambient audio 155 and to perform automated attention handling, accordingly. For example, linguistic name-embedding (LNE) attention handling approaches, universal sound conversion attention handling (USC) approaches, and hybrid universal LNE attention (ULNE) handling system approaches are described in Indian Provisional Patent Application No. 202341085855, titled “AUTOMATED ATTENTION HANDLING IN ACTIVE NOISE CONTROL SYSTEMS BASED ON LINGUISTIC NAME EMBEDDING”, and filed on Dec. 15, 2023. Embodiments of the AHS system 150 described herein use a different approach based on automated acoustic segmentation to detect presence of AS audio 157 and to perform automated attention handling, accordingly. Other related applications are International Application No. PCT/US2024/014606, titled “AUTOMATED ATTENTION HANDLING IN ACTIVE NOISE CONTROL SYSTEMS BASED ON LINGUISTIC NAME EMBEDDING”, filed on Feb. 6, 2024; International Application No. PCT/US2024/014788, titled “AUTOMATED ATTENTION HANDLING IN ACTIVE NOISE CONTROL SYSTEMS BASED ON UNIVERSAL SOUND CONVERSION”, filed on Feb. 7, 2024; and International Application No. PCT/US2024/014820, titled “NAME-DETECTION BASED ATTENTION HANDLING IN ACTIVE NOISE CONTROL SYSTEMS”, filed on Feb. 7, 2024.

Embodiments of the AHS system 150 described herein can be configured specifically to listen for AS audio 157 corresponding to a previously enrolled invocation name (e.g., a name of the user). When the AS audio 157 is detected by the AHS system 150, the AHS system 150 automatically directs the ANC system 140 to switch from the active mode to the conversation mode. In some embodiments, when the AS audio 157 is detected, the AHS system 150 also directs the audio processing system 160 to enter a conversation enhancement mode. As described above with reference to the ANC system 140, the conversation enhancement mode as implemented by the audio processing system 160 can include segregating conversationally relevant audio from the ambient audio 155, adapting equalization of passed through audio to enhance speech, muting or reducing the volume of playback of the desired audio 165, pausing playback of the desired audio 165, etc. Typically, in response to the AS audio 157, the user will begin to engage in a conversation with the attention seeker. Such a conversation can involve the user speaking, and embodiments of the conversation mode of the ANC system 140 and/or the conversation enhancement mode of the audio processing system 160 can include using techniques to help ensure that the user's own speech is not fed back in a manner that results in an apparent echo, feedback noise, or the like. For example, the user's own speech may be captured by a separate beamforming microphone as a user speech audio stream, while ambient audio 155 is being received by the reference microphone 110. The user speech audio stream can be subtracted from the ambient audio 155 prior to passing the signal through other blocks of the system, so that the fed-back audio stream includes only ambient audio other than the user's own speech.

Some embodiments of the AHS system 150, after having detected AS audio 157 and directing the ANC system 140 into conversation mode, can further detect when the conversation ends. Such embodiments of the AHS system 150 can automatically direct the ANC system 140 to return to the active mode, accordingly. As part of returning to the active mode, some such embodiments also return settings (e.g., in the ANC system 140 and/or the audio processing system 160) to those appropriate for listening to the desired audio 165 and suppressing all of the ambient audio 155 (e.g., all frequencies of the ambient audio 155).

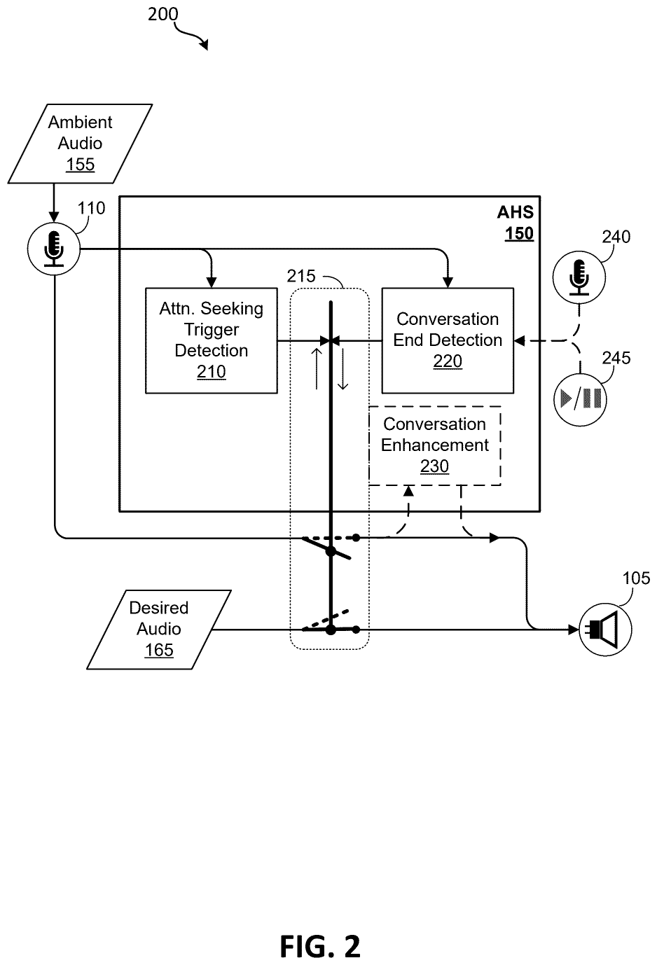

FIG. 2 shows a conceptual circuit block diagram of a partial audio management system environment 200 with an automated attention handling system (AHS) 150. The illustrated environment 200 can be an illustrative portion of the audio management system 100 of FIG. 1, and the AHS 150 can be an illustrative implementation of the AHS 150 of FIG. 1. As illustrated, the AHS 150 includes an attention seeking (AS) trigger detection block 210 and a conversation end detection block 220. Some implementations further include a conversation enhancement block 230. The AHS 150 is illustrated in context of a desired audio 165 stream, a reference microphone 110 that receives ambient audio 155 and outputs an ambient audio stream, and a speaker 105. For the sake of simplicity, the AHS 150 is illustrated without other components of the audio management system 100 of FIG. 1, such as without the ANC system 140 and the audio processing system 160.

The role of the AHS 150 can be generally described as to toggle the audio environment between an active mode and a conversation mode based on whether a desired conversation is detected, as represented by a switch network 215. In the active mode, the user is listening to the desired audio 165 via the speaker 105, and the ANC system 140 (not shown) is suppressing as much of the ambient audio 155 as possible. This is conceptually represented by the switches of the switch network 215 being in the solid-line position, whereby the desired audio 165 passes through to the speaker 105 and the ambient audio 155 does not. When attention seeking audio (i.e., audio associated with getting the user's attention) is detected by the AS trigger detection block 210, the AHS system 150 switches the switch network 215 to the dashed-line position, whereby the ambient audio 155 passes through to the speaker 105 and the desired audio 165 does not. In some embodiments, while in the conversation mode, the passed-through ambient audio 155 (e.g., either all of the ambient audio 155, or a conversationally relevant portion of the ambient audio 155) is passed through the conversation enhancement block 230 in line with the speaker 105. As described above, the conversation enhancement block 230 can use various techniques to enhance conversationally relevant portions of the ambient audio 155. Further, as described above, the conversation enhancement block 230 can be implemented in the AHS system 150, in the ANC system 140, in the audio processing system 160, and/or in any suitable location.

When the end of the conversation is detected by the conversation end detection block 220, the AHS system 150 switches the switch network 215 back to the solid-line position, whereby the desired audio 165 again passes through to the speaker 105 and the ambient audio 155 again does not. In some embodiments, as described above, the end of the conversation is detected based on detecting the user's own speech, such as detecting that the user is no longer speaking for some time, or that the user has issued an audio cue (e.g., “resume ANC”). This user speech can be detected via the reference microphone 110 as part of the ambient audio 155, or detected through a separate microphone 240, such as a beamforming microphone with its beam directed toward the user's mouth. Additionally, or alternatively, some embodiments of the conversation end detection block 220 detect the end of a conversation based on detecting user interfacing with an interface clement, such as detecting that the user pressed a play/pause button 245 on the WAC 210, or the like.

Although the AHS 150 is illustrated as directly coupled with the microphones, the desired audio 165 is directly coupled with the speaker 105 in active mode, the ambient audio 155 is directly coupled with the speaker 105 in conversation mode, etc., some or all of such connections can be through other components that are not shown in FIG. 2. For example, embodiments herein assume that the ambient audio 155 is passing through the ANC system 140, that the desired audio 165 is mixed with an anti-noise signal in active mode, etc.

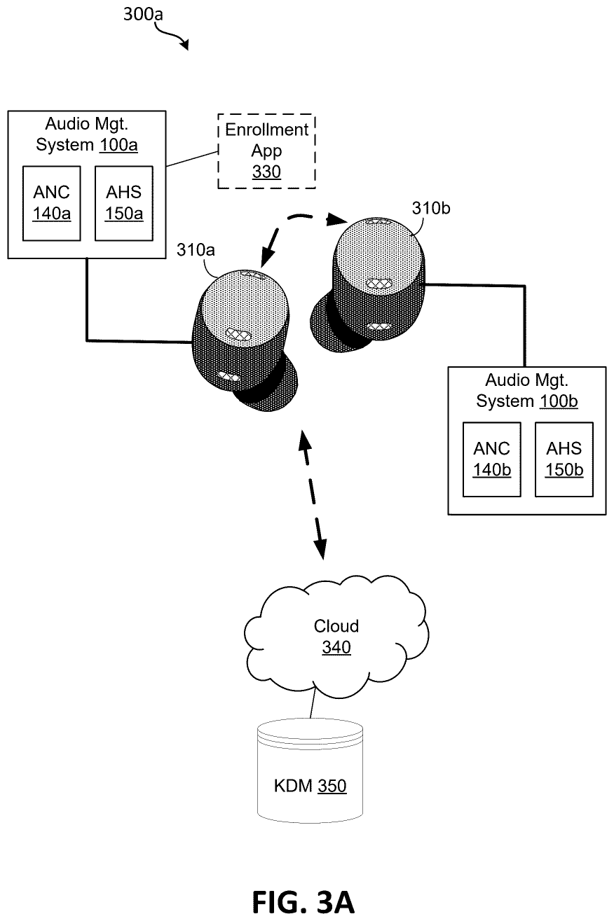

As described herein, embodiments of the audio management system 100 are configured for integration in any suitable WAC. FIGS. 3A and 3B show a wearable audio environment 300 including a pair of WACs 310. Each WAC 310 is illustrated as an earbud. Alternatively, the pair of earbuds can be considered as a single WAC. In other embodiments, the WAC 310 can be implemented as over-ear headphones, or any other suitable wearable audio component that incorporates ANC. In the illustrated embodiments, each WAC (i.e., each earbud) has a respective instance of an audio management system 100, such as the audio management system 100 of FIG. 1, and each instance of the audio management system 100 includes a respective instance of at least an ANC system 140 and an AHS system 150. Though not explicitly shown, each WAC 310 also has, integrated therein, an instance of the speaker 105, the reference microphone 110, the error microphone 115, one or more processors, and non-transitory processor-readable storage. Some implementations of the WAC 310 include additional components, such as instances of the audio processing system 160, one or more additional microphones (e.g., a beamforming microphone), one or more additional speakers, interface controls (e.g., one or more buttons), one or more power sources (e.g., a rechargeable battery), one or more ports (e.g., physical ports for charging and/or wired communication, logical ports for wireless charging and/or wireless communication), one or more antennas, etc.

In some embodiments, the one or more processors integrated in the WAC 310 implement components of the respective audio management system 100 instance. For example, a non-transitory processor-readable medium integrated therein has processor-executable instructions stored thereon, which, when executed, cause the set of processors to implement at least features of the respective ANC system 140 and/or AHS system 150 instances. As described herein, embodiments of the AHS system 150 include one or more types of artificial neural networks, corresponding trained network models, or the like. In some embodiment, such networks and/or models are implemented using specialized hardware, such as neuromorphic chips. In other embodiments, such networks and/or models are implemented by using processor-readable instructions to reconfigure general-purpose computing hardware (e.g., a central processing unit, CPU), specialized AI accelerators.

Turning specifically to FIG. 3A, a first type of wearable audio environment 300a is shown in which one or both WACs 310 is in communication with a cloud computing environment (“cloud”) 340. For example, the cloud 340 includes a server, or several distributed servers, accessible via the Internet. Though the WAC 310 is shown as directly in communication with the cloud 340, such a connection can be facilitated by any suitable intermediary devices, such as routers, hubs, etc. As described further herein, automated attention handling features described herein rely on generation of an inference model that includes several neural networks and/or models. In the illustrated embodiments of FIG. 3A, the inference model is generated by the local computation environment of the WAC 310 and/or based on information ported to the WAC 310 from the cloud 340.

As described herein, some embodiments involve enrollment of invocation names for use in name detection. In the embodiments of FIG. 3A, an enrollment application 330 is downloaded to the local computational environment of the WAC 310, and the enrollment application 330 is used for such enrollment. The enrollment application 330 can facilitate generation of the inference model, based on a teacher model, referred to herein as a knowledge distillation model (KDM) 350. As illustrated, the KDM 350 can be stored in the cloud 340. In some embodiments, the KDM 350 is accessible to the WAC 310 (e.g., to the enrollment application 330) via the cloud 340. Reference to the “inference model” can include some or all of a name embedding model, a deep image, a relation network, and a false rejection network. Each is described more fully below.

Turning to FIG. 3B, some embodiments of the wearable audio environment 300b further include a user computational device 320 separate from the WAC 310. For example, the user computational device 320 can be a smartphone, laptop computer, tablet computer, smart watch, portable audio player, or any other suitable device that is separate from the WAC 310 and includes its own one or more processors and its own one or more non-transitory storage media for storing processor-readable instructions. The user computational device 320 can be in communication with each WAC 310 via any suitable wired and/or wireless communication link, such as via an audio cable (e.g., via a 3.5-millimeter or ¼-inch analog audio jack), a universal wired connection (e.g., universal serial bus (USB)), a short-range universal wireless connection (e.g., Bluetooth, short-range radiofrequency, near field communication (NFC)), an optical connection (e.g., infrared), a proprietary connector, a multi-pin connector, an intermediary component or platform (e.g., a docking station or dongle), etc.

Similar to the embodiments of FIG. 3A, the embodiments of FIG. 3B can include an enrollment application 330, communications with the cloud 340, use of a KDM 350, etc. As illustrated in FIG. 3B, these features can be facilitated via the user computational device 320 (rather than directly by the WAC 310). For example (as described more fully below), when a user first registers the WAC 310 (e.g., first attempts to pair the earbuds with the user computational device 320), the user computational device 320 automatically accesses and/or downloads the enrollment application 330, or prompts the user to access and/or download the enrollment application 330. The enrollment application 330 can be downloaded from the cloud 340, or from any other suitable environment. The enrollment application 330 can then access the KDM 350 via the cloud 340 and can use the KDM 350 to generate an inference model for automated attention handling. For example, to facilitate LNE-AHS, the inference model includes some or all of a name embedding model, a deep image, a relation network, and a false rejection network. The generated inference model can then be ported to the WAC 310. For example, the inference model can be ported from the user computational device 320 to both earbuds; ported from the user computational device 320 to a master earbud, and from the master earbud to a slave earbud; etc.

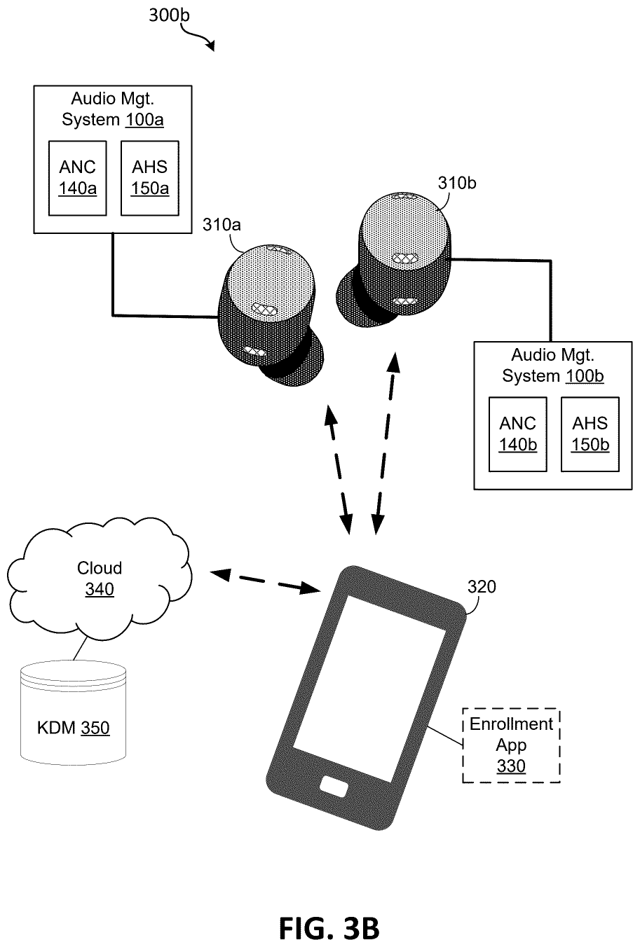

Embodiments generally build an inference model for storing at the WAC 310 to enable the WAC 310 to subsequently use the inference model to perform automated attention handling, as described herein. FIG. 4 shows a simplified block diagram of stages of an illustrative implementation of an attention seeker (AS) trigger detection block 400 and the association of each stage with a corresponding portion of a generated inference model, according to embodiments described herein. The AS trigger detection block 400 can be an implementation of the AS trigger detection block 210 of FIG. 2. It is assumed that the AS trigger detection block 400 is implemented in the context of a WAC 310.

Embodiments can include an enrollment stage 410, an identification stage 430, and a verification stage 440. In general, the enrollment stage 410 occurs outside of normal operation of the WAC 310, such as when a user first sets up and/or uses the WAC 310, when the user first registers the WAC 310, when the user first configures the WAC 310 for automated attention handling, etc. The identification stage 430 and the verification stage 440 are real-time blocks that occur during normal operation of the WAC 310 to facilitate real-time automated attention handling. Embodiments generally use the enrollment stage 410 to obtain any information needed to set up an inference model for storing at the WAC 310 to enable the WAC 310 to perform automated attention handling features during normal operation. As shown, the inference model includes at least an embedding model 415, a relation network 435, and a false rejection network 445.

In the enrollment stage 410, the embedding model 415 can be used to convert an enrollment audio stream 405 into a set of reference embeddings based on a KDM 350. The KDM 350 can be stored in and accessed via the cloud 340 (e.g., and/or any other suitable communication network). The reference embeddings can be stored as a deep image 420. The deep image 420 can also be considered as part of the inference model.

During normal operation, in the identification stage 430, a real-time (RT) audio stream 407 is received. The embedding model 415 (i.e., the same embedding model 415 generated in the enrollment stage 410) is used to generate a RT embedding from the received RT audio stream 407. The relation network 435 can then compare the RT embedding with each of the reference embeddings in the deep image 420 to determine if there is a match. For example, the relation network 435 is configured to compute a similarity score for each comparison (e.g., corresponding to a mathematical correlation, or the like). The relation network 435 can determine if any similarity scores meet or exceed a predetermined threshold; if so, the reference embedding with the highest similarity score can be selected as a candidate matching embedding.

In the verification stage, the false rejection network 445 can then confirm the match by transforming the RT embedding and the candidate matching embedding into different mathematical spaces (e.g., domains) and determining whether the embeddings can be reliably discriminated from each other in any of the mathematical spaces. For example, the deep image 420 is configured to compute a discrimination score for each mathematical space. The deep image 420 can determine if any discrimination scores meet or exceed a predetermined threshold; if so, the match determined by the relation network 435 is determined to be a false match and is ignored. If the embeddings cannot be sufficiently discriminated in any mathematical spaces, the false rejection network 445 can output a signal that attention seeking audio has been detected.

As described herein, embodiments of the attention seeker (AS) trigger detection block 400 are configured to detect an invocation name as part of an attention handling system. The embedding model 415 is a name embedding model (e.g., a processor-executable name embedding model) that generates an output embedding from an audio sample. As used herein, the terms “audio sample” or an “audio signal” are used interchangeably in the context of an input to a component of the inference model; such an “audio sample” or an “audio signal” can be represented in any suitable manner, such as by any suitable number of digital samples. For example, reference to an input as an “audio sample” means an audio signal of a duration, or a sampled duration of an audio signal, at a sampling rate resulting in a large number of digital samples (e.g., one second of audio sampled at 16 kHz to yield 16,000 samples). As described above, the audio sample can be from an enrollment audio stream 405 in an enrollment stage 410, and the audio sample can be from a RT audio stream 407 during normal operation. The name embedding model 415 is trained to classify a corpus of real-world name audio samples into a linguistically differentiated set of name classifications. The deep image 420 (e.g., a processor-readable deep image) includes reference name embeddings generated by the name embedding model 415 based on a set of invocation names provided by a user during an enrollment procedure. The relation network 435 (e.g., a processor-executable relation network) is coupled with the deep image 420 and the name embedding model 415 to output a candidate name embedding responsive to determining that one of the reference name embeddings has a highest similarity with a RT embedding generated by the name embedding model 415. The RT embedding can be from a RT audio stream 407 received from a reference microphone associated with an ANC system of the WAC 310. The false rejection network 445 (e.g., a processor-executable false rejection network) is coupled with the relation network 435 to output a name invoked signal 450 responsive to determining that the real-time embedding and the candidate name embedding cannot be reliably discriminated. As described herein, the name invoked signal 450 can direct an ANC system of the WAC 310 automatically to enter a conversation mode.

As described above, the interference model used for automated attention handling is based on a teacher model, referred to herein as a knowledge distillation model (KDM) 350. As described in detail below, the KDM 350 is used to train other portions of the inference model using knowledge distillation techniques. Embodiments of the KDM 350 are generated from a large speech-audio corpus of diversified words spoken by diversified speakers. “Diversified words” refers herein to the speech-audio corpus including a wide variety of at least phonemes and linguistic information. “Diversified speakers” refers to the speech-audio corpus representing a wide variety of at least accents and prosody. The speakers can be further diversified with respect to age, gender, geography, etc. For example, the speech-audio corpus includes tens of thousands of words (i.e., classifications) spoken multiple times (e.g., 10-15 times) by hundreds of speakers from around the world.

The term “suprasegmental” is used herein as an umbrella term to encompass properties of a speaker's influence when speaking words, such as accent, prosody, intonation, rhythm, and other non-segmental aspects of speech. Such suprasegmental features can be contrasted with segmental features pertaining to individual speech sounds or segments, such as vowels and consonants, and can span multiple segments or an entire utterance. Examples of suprasegmental features of an utterance (e.g., a word, name, etc.) can include accent (including accent-influenced variations in pitch, loudness, and duration), prosody (including rhythm, intonation, and melody of speech), intonation (i.e., the rise and fall of pitch in speech), rhythm and/or rate (e.g., the temporal patterns of speech, such as duration and timing of sounds, syllables, and pauses), and stress (e.g., emphasis placed on a particular syllable). For example, a large speech-audio corpus of diversified words spoken by diversified speakers may include hundreds or thousands of samples of a particular word being spoken with wide suprasegmental variance over the samples.

Training of the KDM 350 is described in detail below. In general, the training can begin with an encoder-decoder architecture, transformer network, conformer network, or the like, which are types of neural network architecture designed to learn compact representations of data, such as so-called “latent features,” audio tokens, or a combination thereof. In the context of embodiments described herein, the auto-encoder architecture is used to extract meaningful features from raw audio data to be used for automatic speech recognition (ASR). The goal of training is for the KDM 350 to learn how to convert many different instances of input labels that all represent suprasegmentally varying samples of a same class into a common set of output labels to represent that class, and to learn how to do that for a large speech-audio corpus of diversified classes. The terms “class” and “word” are used interchangeably herein and are intended to mean any type of word, name, or utterance that could reasonably be used to get someone's attention, such as “John,” “mister,” “hey,” “excuse me,” etc. In particular, the KDM 350 is trained to automatically segment a spoken sample of a word into a same set of acoustical segments, regardless of suprasegmental influence on the sample by the speaker (e.g., the speaker's accent, prosody, etc.).

In general, the KDM 350 architecture includes three high-level stages: an encoder, a bottleneck layer, and a decoder. The encoder receives a high-dimensionality input (i.e., the raw audio data) and includes a multi-layer network to progressively reduce the dimensionality of the data using transformations. For example, the ASR information is represented as a sequence of audio frames, each including features that can be mathematically described as Mel-frequency cepstral coefficients (MFCCs), or in some other manner. Each layer of transformations (e.g., linear operations followed by non-linear operations, such as a rectified linear unit (ReLU) function) seeks to extract increasingly abstract and higher-level features from the input data.

The bottleneck layer is so called because it typically includes significantly lower dimensionality than the layers of the encoder before it and or the decoder after it. This reduced dimensionality effectively forces the network to learn a compressed and informative representation of the input data. Effective training results in the bottleneck layer producing a highly compact, but highly meaningful representation of the input data; effectively extracting the most salient features for the desired task. Embodiments of the KDM 350 are asymmetric, such that the decoder is not the reverse of the encoder. Instead, the decoder seeks to convert the bottleneck features into a particular set of output labels, such as a posterior probability matrix (PPM) and/or an ordered acoustical segment vector (OASV), as described more fully below. The decoder takes the output of the bottleneck layer as its input data (i.e., a lowest-dimensionality representation) and applies multiple layers of transformations to reach a representation of the data matching the desired output labels.

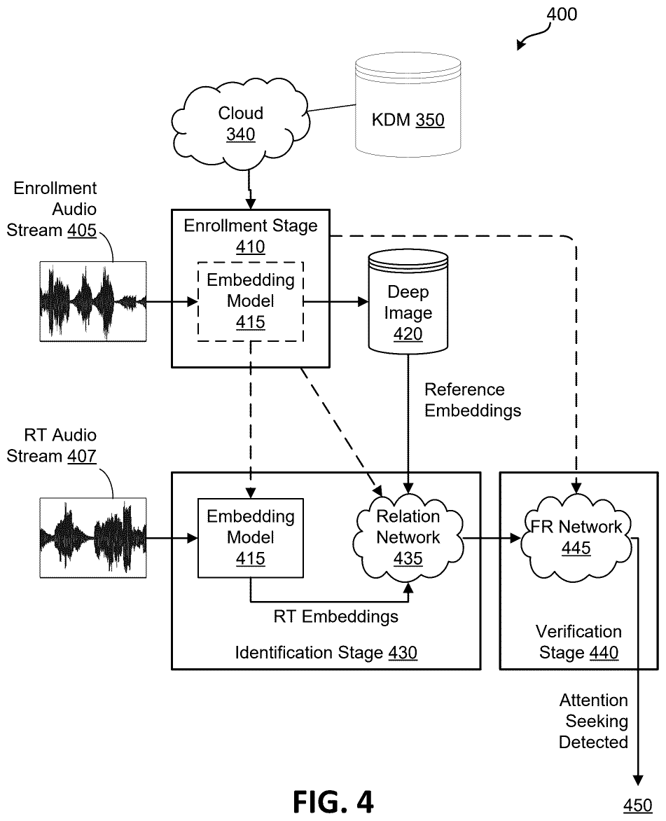

FIGS. 5-9B illustrate training of the KDM 350 for use with embodiments described herein. FIG. 5 shows a training environment 500 for implementing a first phase of training the knowledge distillation model (KDM) 350. As illustrated, the training environment 500 includes a spoken word audio repository 510 and a training auto-supervisor 520. In the context of FIG. 5, the KDM is labeled as KDM 350′, representing that the KDM is in the first training phase. In the first training phase, the KDM 350′ is trained to convert class audio samples from the spoken word audio repository 510 into corresponding posterior probability matrices (PPMs) 530.

The spoken word audio repository 510 can include one or more large corpuses of spoken audio data. Preferably, the corpuses include many words (classes), and many diversified samples in each class, so that each class includes many versions of the same word spoken with wide suprasegmental variance. For example, a given word may be spoken 10,000 times by different speakers from around the world. Thus, for each class, the spoken word audio repository 510 can output a large number of diversified audio samples for the class, which can be referred to as the “class audio samples” for the class.

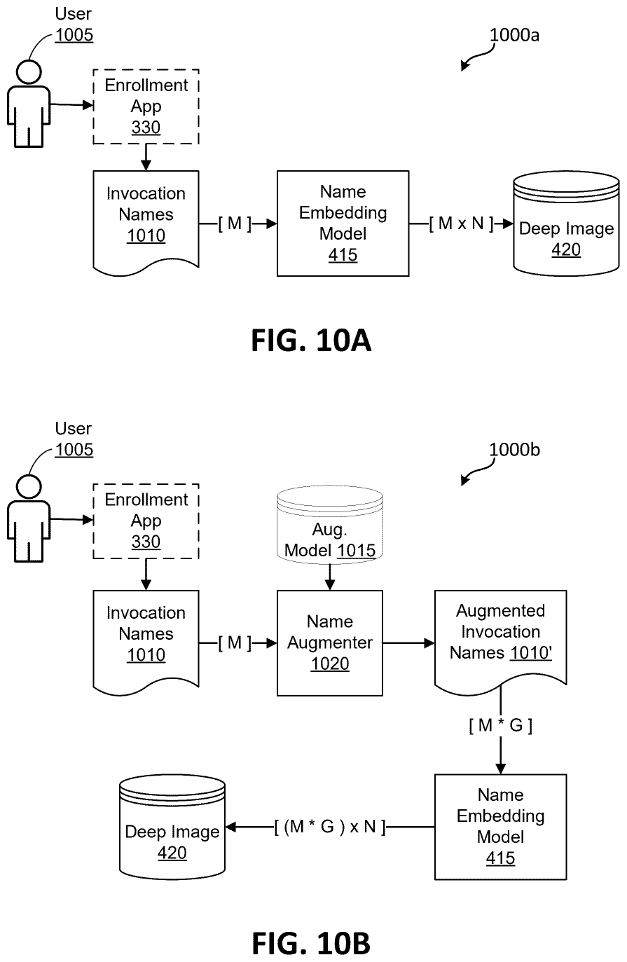

The class audio samples for each class can form the entire set of spoken audio samples for that class. For example, if the spoken word audio repository 510 includes S samples for a particular class (S is a positive integer), there are S class audio samples. In other embodiments, additional variation in the audio samples for each class is created by passing the class audio samples through an augmenter (part of the training auto-supervisor 520, not explicitly shown). The augmenter uses one or more augmentation models to generate an augmented set of class audio Samples with variations in features, such as speech speed (e.g., lengthening or shortening of the audio sample, lengthening or shortening of some or all vowel sounds, etc.), modeled suprasegmental variations, models of noise profiles and/or ambient noise features (e.g., traffic sounds, background conversation sounds, etc.), etc. Some embodiments of the augmenter are implemented in the same manner as the name augmenter 1020 of FIG. 10B (e.g., and the augmentation models used by the training auto-supervisor 520 can be the same as, or different from the augmentation models 1015 of FIG. 10B). Other embodiments of the augmenter introduce more and/or different types of variation using more and/or other augmentation models. In embodiments of the training auto-supervisor 520 that include the augmenter, the augmented set of audio samples for the class is used as the class audio samples. For example, if the augmenter produces A augmentations for each of the S class audio samples from the spoken word audio repository 510 (A is a positive integer), there will be A*S class audio samples used by the training auto-supervisor 520. In some cases, the spoken word audio repository 510 may include different numbers of samples for different classes, and/or the augmenter may apply different types of augmentations for different classes, such that the values of A and/or S may be class dependent.

As noted above, in the first training phase, the training auto-supervisor 520 trains the KDM 350′ to generate PPMs 530. The training auto-supervisor 520 is automated and is implemented by a processor. Embodiments of the KDM 350′ can use any suitable neural network architecture tailored for capturing features in audio data, such as a convolutional neural network (CNN), a conformer network, a transformer network, a recurrent neural network (RNN), a convolutional recurrent neural network (CRNN), etc. Embodiments of the training auto-supervisor 520 can begin by pre-processing the class audio samples into suitable input labels for use by the encoder (e.g., the input layer) of the KDM 350′. For example, the class audio samples can be resampled and/or normalized, and certain features can be extracted, such as using spectrograms or Mel-frequency cepstral coefficients (MFCCs). The input layer(s) of the KDM 350′ can also be tailored to receiving of the pre-processed audio samples, such as by having a number of dimensions corresponding to the number of MFCCs, or the like.

As described above, the encoder portion of the KDM 350′ can include several layers, such as convolutional and/or recurrent layers, to progressively reduce the dimensionality of the input class audio samples into corresponding, highly compressed representations. The layers seek to identify the most salient acoustical features based on temporal dependencies, frequency patterns, and/or other relevant information patterns. Generation of the PPMs 530 can be considered as a classification task, such that the decoder portion of the KDM 350′ is a classifier that includes as many nodes as there are cells in the PPM 530. For example, the output layer(s) of the KDM 350′ can effectively implement an activation function that allows the input to be a member of multiple classes (e.g., the sigmoid activation function), such that the values at the output nodes of the KDM 350′ represent the likelihood of the input belonging to a corresponding cell in the PPM 530. In some implementations, as illustrated, each PPM 530 is a J×K matrix, such that the output of the KDM 350′ includes J*K classification nodes.

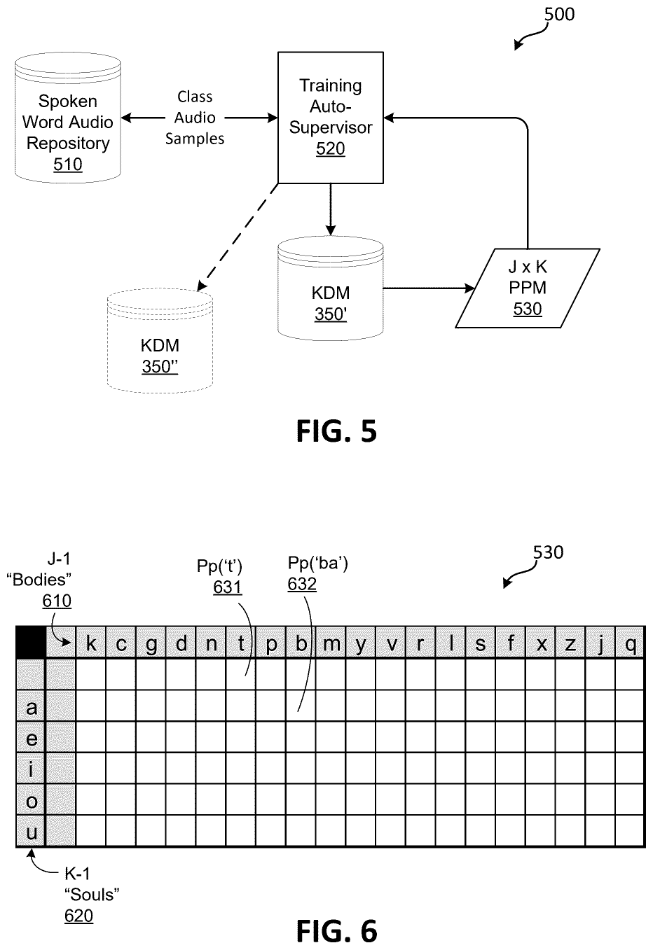

For example, FIG. 6 shows an example of a PPM 530 represented as a J×K matrix (i.e., with J*K cells). The illustrative PPM 530 represents sounds of the English language using 19“bodies” (columns) and 11 “souls” (rows). Each body generally corresponds to a particular consonant sound or set of related consonant sounds. For example, the body labeled ‘s’ represents the sounds ‘s’ and ‘sh.’ Each soul generally corresponds to a vowel sound (or corresponding range thereof). Each cell (i.e., each column-row intersection) corresponds to an acoustical unit, and the value in that cell represents the posterior probability of an input audio sample including that acoustical unit. Further, the PPM 530 includes an additional row to account for lone bodies (i.e., without a soul) and an additional column to account for lone souls (i.e., without a body). As such, the illustrated PPM 530 includes 20 columns (i.e., J=20) and 7 rows (i.e., K=7). For example, a value in cell 631 represents the posterior probability of the acoustical unit ‘t’ (labeled as “Pp(‘t’)”), and a value in cell 632 represents the posterior probability of the acoustical unit ‘ba’ (labeled as “Pp (‘ba’)”).

It can be seen that the illustrated PPM 530 does not include all the letters in the English language. For example, the PPM 530 does not include ‘h’, ‘v’, or ‘w’; as those consonant sounds can tend to be reliably represented in their spoken context by other acoustical units. Further, the cells of the illustrated PPM 530 do not map directly to all of the phonemes in the English language. For example, many linguists classify the English language into 44 phonemes, and the illustrated PPM 530 includes 140 cells (i.e., 20×7). Other implementations of the PPM 530 can include any suitable number of cells corresponding to any suitable set of acoustical units. For example, the PPM 530 can be tailored to different languages, dialects, or regional variations, etc.

Returning briefly to FIG. 5, the training is an iterative and automated process. As illustrated, the training auto-supervisor 520 repeatedly directs the KDM 350′ to generate PPMs 530, receives the generated PPMs 530 as feedback, and adjusts the KDM 350′ until all class audio samples representing a same class (or at least a threshold number) yield a same PPM 530 for the class. For example, the training auto-supervisor 520 seeks to minimize a loss function (e.g., cross-entropy) to find the most representative PPM 530 for each class. When the KDM 350′ is trained in accordance with the first phase, it can be considered as KDM 350″ (i.e., moved to a second training phase).

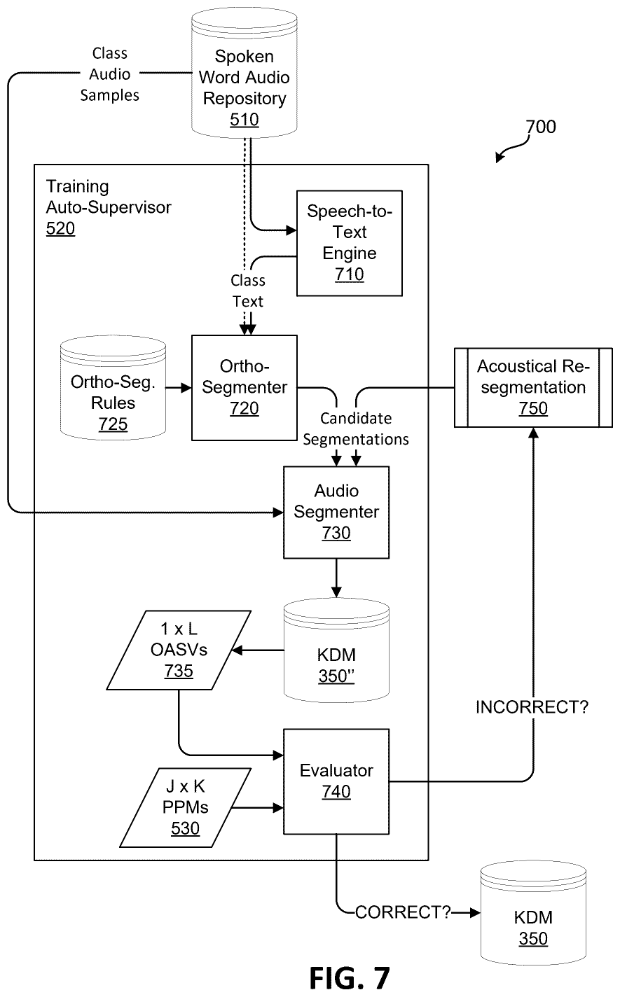

FIG. 7 shows a training environment 700 for implementing a second phase of training the knowledge distillation model (KDM) 350. As in the training environment 500 of FIG. 5, the training environment 700 includes the spoken word audio repository 510 and the training auto- supervisor 520. In the context of FIG. 7, the KDM is labeled as KDM 350″, representing that the KDM is in the second training phase. In the second training phase, the KDM 350″ is trained to use the PPMs 530 as a guide for acoustically segmenting the class audio samples from the spoken word audio repository 510 into corresponding acoustical segment vector (OASVs) 735.

As shown, the second training phase can include two sub-phases. In a first sub-phase, embodiments of the training auto-supervisor 520 automatically segment class audio samples into candidate segmentations based on ortho-segmentation rules 725. As used herein, “ortho- segmentation” refers to segmentation of a word into orthographic units that are based on the orthography (i.e., the written form) of the word. In some embodiments, the spoken word audio repository 510 includes a lexical entry for each of some or all of the classes, which can be used directly as “class text.” For example, the term “INDEPENDENCE” can have hundreds of diversified spoken audio samples for the word, all stored in association with a lexical entry (i.e., the text) for the word. In other embodiments, the spoken word audio repository 510 may not include lexical entries for classes, or may not include a lexical entry for one or more classes. In such embodiments, for any class that does not have an associated lexical entry, one or more of the repository spoken audio samples is fed to a speech-to-text (STT) engine 710, which generates the class text from the class audio sample(s) as received from the spoken word audio repository 510.

The class text (whether received from the spoken word audio repository 510 or the STT engine 710, is passed to an ortho-segmenter 720. The ortho-segmenter 720 is a parser that converts the class text to a candidate segmentation based on ortho-segmentation rules 725. The ortho-segmentation rules 725 is represented as storage in FIG. 7, indicating that, embodiment of the ortho-segmentation rules 725 are stored in a non-transitory, processor-readable storage medium. For example, the ortho-segmentation rules 725 can be stored as a set of functions, scripts, or the like, which can be executed by the ortho-segmenter 720 on the class text. An example set of ortho-segmentation rules 725 is as follows:
a) Segment before or between constriction (i.e., where the lips touch together or the tongue touches the upper or lower palate), such as/p/, /ph/, /t/, /th/, /d/, /dh/, /1/, /lh/, /b/, /bh/, /g/, /k/, /n/, /m/, /s/, /sh/, /x/, /f/, /z/, /zh/.
b) For trilling: (1) segment before trilling, if /r/ is not followed by plosives such as /t/, /k/, /g/, or /d/; (2) segment before plosives such as /t/, /k/, /g/, and/d/that succeed trilling /r/; (3) segment the trilling/r/after the vowel, if succeeded by vowels, such as /a/, /e/, /i/, /o/, /u/; and (4) segment the trilling/r/alone, if it is not proceeded or succeeded by the aforesaid plosives or vowels, respectively.
c) Segment before a nasal phoneme (n, m), if it continues with carriers or vowels. Otherwise, segment after the nasal phoneme.
d) Segment before and after fricatives, such as /sh/, /ch/, /f/, /x/, /z/, /zh/.
e) Treat parallel vowels, such as /j/ and /q/, separately by combining/j/and/q/with succeeding vowels.
f) Segment consecutive carriers, if both carriers are succeeded and preceded by a body.
g) Combine end-plosives, such as /k/, /d/, /t/, /b/, /g/, and /l/.

The candidate segmentation for each class automatically generated by the ortho-segmenter 720 can be fed into an audio segmenter 730, along with some or all of the class audio samples for the corresponding class. The output of the audio segmenter 730 is a sequence of audio chunks of each class audio sample, where each audio chunk corresponds to a respective unit of the candidate segmentation. The audio chunks can be fed into the KDM 350″ as input labels for the second training phase. For example, feeding the audio chunks into the KDM 350″ can involve preprocessing the audio chunks into MFCCs, or the like. As illustrated, the second training phase trains the KDM 350″ to generate OASVs 735 from the sequences of audio chunks.

Each OASV 735 is a 1×L vector, where L is a positive integer (e.g., 16) corresponding to a maximum number of acoustical units that can be used for acoustical segmentation by the KDM 350″. In the first training phase, the KDM 350′ is trained as a classifier, where the classification output nodes correspond to the J*K cells of the PPM 530. In the second training phase, the classification knowledge of the KDM 350″ is used to classify each audio chunk sequentially as a corresponding one of the cells of the PPM 530. For example, the KDM 350″ tries to use all of the first audio chunks from all of the class audio samples for a particular class (in accordance with the candidate segmentation) to figure out a best-matching cell from the PPM 530 to represent the audio chunk. Classifying the sequence of audio chunks results effectively in a sequence of PPM 530 cells determined to represent the sequence of acoustical segments that best correspond to the sequence of audio chunks, and that sequence of PPM 530 cells can be represented as the OASV 735. Embodiments of the KDM 350″ can be implemented with an output layer having L output nodes corresponding to the L elements of the OASV 735. Where fewer than L acoustical segments are used, the remaining elements of the OASV 735 can include a default value (e.g., ‘−1’) that does not correspond to any of the cells of the PPM 530.

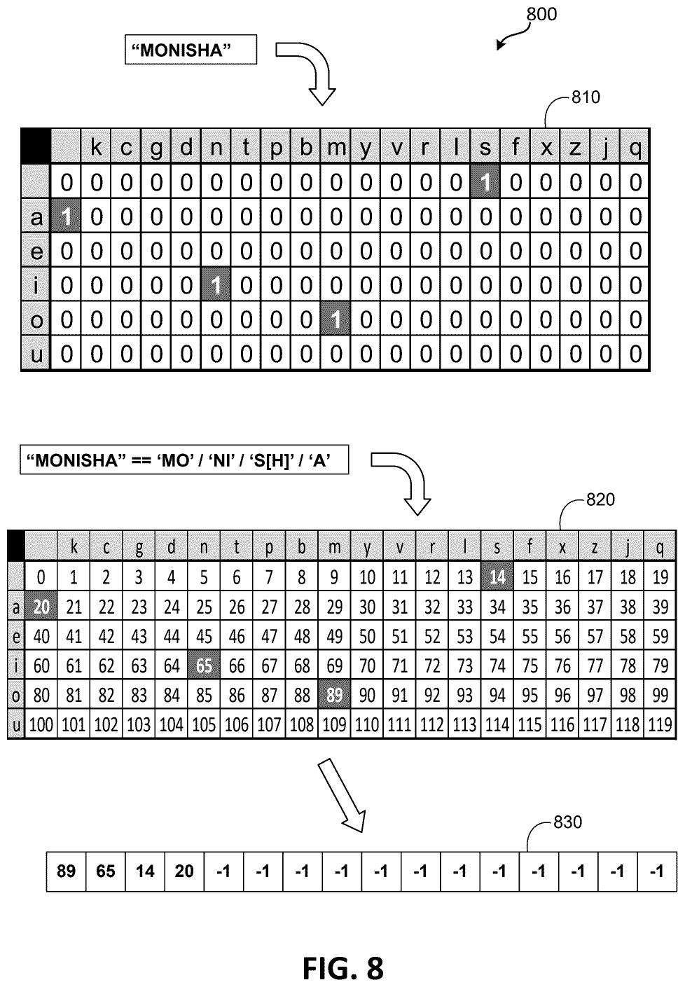

For example, FIG. 8 shows an illustrative candidate segmentation and an illustrative corresponding PPM 810 and OASV 830. The PPM 810 can be an example of PPM 530, and OASV 830 can be an example of OASV 735. In the example, the class (name) “MONISHA” has been classified to generate PPM 810. The PPM 810 shows cells having a value of ‘1’ where the corresponding acoustical segments is found by the classification to be present in the class audio samples for “MONISHA”. In the illustrated example, a ‘1’ is present in the cells corresponding to acoustical units ‘mo’, ‘ni’, ‘s[h]’, and ‘a’ (as mentioned above, the unit ‘s’ also represents the fricative ‘sh’).

FIG. 8 also shows an illustrative index matrix 820. The index matrix 820 is the same size as the PPM 810, and each cell of the index matrix 820 has a unique value that represents an index to the corresponding cell of the PPM 810. For example, the acoustical segment ‘ni’ corresponds to cell index ‘65’. Each audio chunk can be classified as the one of the index values from the index matrix 820 corresponding to the PPM 810 cell that is the best-matching acoustical segment. In some implementations, the classification of each audio chunk yields a value, and the value is rounded to the nearest cell index value in the index matrix 820. In one implementation, rather than each index being separated from its neighbors by ‘1’ (as shown), each index can be separated from its neighbors by ‘100’. For example, instead of indexing the cells as ‘0’, ‘1’, ‘2’, etc., they can be indexed as ‘0’, ‘100’, ‘200’, etc. (i.e., each index shown in index matrix 820 can be multiplied by 100). In such an implementation, ‘mo’ corresponds to index ‘8900’, and any classification result between 8850 and 8949 can be classified as ‘mo’. The difference between neighboring index values can effectively operate as a quantization resolution, and different implementations can use any suitable quantization resolution.

In the example illustrated by FIG. 8, the class “MONISHA” has been segmented into a candidate segmentation: ‘MO’/‘NI’/‘S[H]’/‘A’. For example, the class has automatically been ortho-segmented by the ortho-segmenter 720 according to ortho-segmentation rules 725. The illustrated OASV 830 is a 16×1 vector. Because “MONISHA” was segmented into four segments, the first four elements of the OASV 830 point to a sequence of cells of the PPM 810, and the remaining 12 elements show a default entry of ‘−1’. The first four elements index the sequence of acoustical segments that best represent the sequence of audio chunks according to the candidate segmentation. It can be seen that, if the candidate segmentation produced the correct acoustical segmentation (i.e., an acoustical segmentation matching the spoken form of the class), the acoustical segments identified by the OASV 830 will match those predicted by the PPM 810 (as happens to be the case in the illustrated example).

Returning to FIG. 7, the training auto-supervisor 520 can include an evaluator 740 that automatically determines whether the candidate segmentation appears to produce a good acoustical segmentation. Embodiments of the evaluator 740 can evaluate the generated OASV 735 for a class based on the generated PPM 530 for the class to determine whether the set of acoustical segments represented by the OASV 735 matches those in the PPM 530. Embodiments of the PPM 530 indicate which acoustical segments are probabilistically present in the class audio samples, but it may not represent the order of those segments. If the OASV 735 represents an accurate acoustical segmentation of the class audio samples, it should indicate the same set of acoustical segments as indicated by the PPM 530 (and the order of those acoustical segments).

Words are frequently pronounced in a manner that does not match a relatively small and rigid set of rules based on the word's orthography (i.e., ortho-segmentation rules 725). As such, it can be expected that automated segmentation by the ortho-segmenter 720 based on ortho-segmentation rules 725 will yield some incorrect candidate segmentations. After the first sub-phase of the second training phase, there will be some percentage (e.g., X%) of candidate segmentations determined by the evaluator 740 to be “correct,” and some percentage (e.g., Y%) of candidate segmentations determined by the evaluator 740 to be “incorrect.”

As illustrated, the classes that were not correctly segmented by the ortho-segmenter 720 can be identified for performance of the second sub-phase of the second training phase: acoustical re-segmentation 750. In some embodiments, the evaluator 740 automatically generates and outputs a set (e.g., a list) of the classes for which automated ortho-segmentation resulted in an incorrect acoustical segmentation. The acoustical re-segmentation 750 can be performed on the identified set of incorrectly segmented classes. In some embodiments, the acoustical re-segmentation 750 is a manual process (e.g., the only manual portion of the training) by which a human trainer or trainers can attempt to find a re-segmentation that better represents the acoustic segments. In other embodiments, the acoustical re-segmentation 750 is a fully automated, or partially automated process. For example, in each iteration of the second training phase, embodiments can use a different subset of ortho-segmentation rules (e.g., from the stored rules 725), can modify previously applied ortho-segmentation rules (e.g., in random or pre-defined ways), etc.

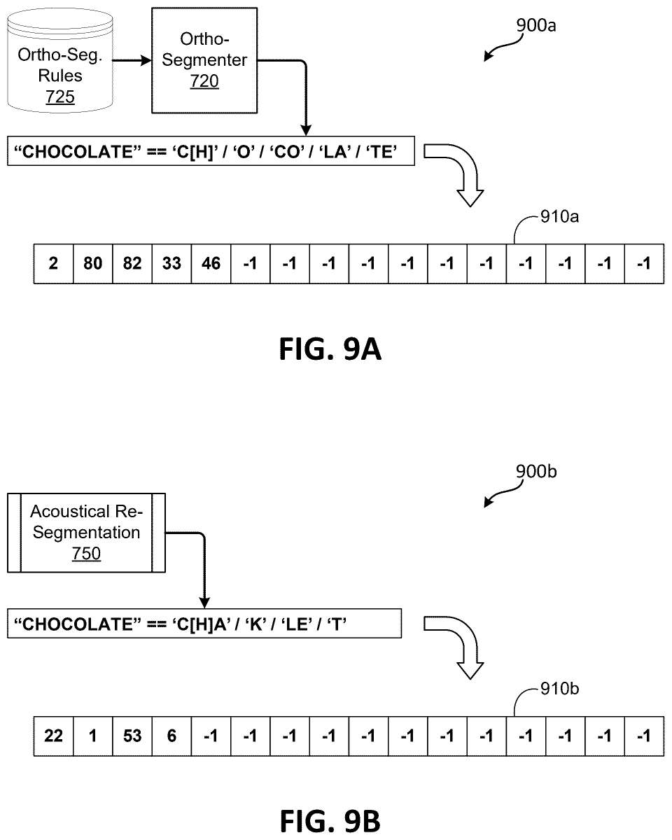

For example, FIGS. 9A and 9B show example OASVs 910 resulting from an illustrative automated ortho-segmentation and an illustrative re-segmentation, respectively. Turning first to FIG. 9A, the class “CHOCOLATE” is automatically segmented by the ortho-segmenter 720 in accordance with stored ortho-segmentation rules 725, resulting in a candidate segmentation:

‘C[H]’/‘O’/‘CO’/‘LA’/‘TE’. This candidate segmentation, after classification by the KDM 350″, results in an OASV 910a of [2, 80, 82, 33, 46] (the remaining elements in the vector are unused, as represented by the value ‘−1’). It can be assumed that this OASV 910a does not sufficiently correspond to the PPM for the class.

Turning to FIG. 9B, the class “CHOCOLATE” is now re-segmented (according to the acoustical re-segmentation 750 sub-phase, such as manually) into a different candidate segmentation: ‘C[H]A’/‘K’/‘LE’/‘T’. This candidate segmentation, after classification by the KDM 350″, results in a OASV 910b of [22, 1, 53, 6] (the remaining elements in the vector are unused, as represented by the value ‘−1’). It may be that this OASV 910b does sufficiently correspond to the PPM for the class. If not, the class may be passed back through the acoustical re-segmentation 750 sub-phase.

Returning to FIG. 7, the second sub-phase of the second training phase can be iterative. For example, after automated ortho-segmentation (i.e., the first sub-phase of the second training phase), X may be 80 and Y may be 20, such that 20% of the classes were incorrectly segmented by the ortho-segmenter 720. Those 20% are passed to the acoustical re-segmentation 750 sub-phase and are re-segmented. All of the classes are again passed through the KDM 350″ to generate corresponding OASVs 735. Passing all of the classes back through the KDM 350″ (i.e., as opposed to repeating the process only for those classes that were incorrectly segmented in the previous iteration) can help to correct any inherent error in the KDM 350″ itself. For example, it is possible that a class that was correctly segmented in one iteration will be incorrectly segmented in a subsequent iteration because of changes to the KDM 350″, but it is assumed that this still represents an overall improvement to the KDM 350″. After this second iteration (i.e., after manual re-segmentation) X may now be 90 and Y may now be 10, such that only 10% of the classes are now being incorrectly segmented. Those 10% can be passed again to the acoustical re-segmentation 750 sub-phase and can be re-segmented differently.

The second sub-phase process can repeat until a training satisfaction level is reached: either X is above a predetermined threshold, Y is below a predetermined threshold, or the segmentations of all classes result in correct acoustical segmentations. As illustrated, once the training satisfaction level is reached, the KDM 350″ can be considered as the KDM 350 for use in training the inference model for name-detection-based attention handling, as described herein. With training of the KDM 350 complete, the KDM 350 is capable of automatically generating a correct acoustical segmentation from an input audio sample to at least a predetermined confidence level. Moreover, the training is such that even suprasegmentally varied versions of a same class will be converted by the KDM 350 into a same OASV 735.

Returning to FIG. 4, the trained KDM 350 can now be used to train the name embedding model 415 of the inference model. Training of the name embedding model 415 is performed by applying knowledge distillation from the KDM 350 based on a smaller corpus of real-world name data. For example, the KDM 350 can use a large number (e.g., 11,000) of classifications to generate the PPMs 530 and OASVs 735, and the name embedding model 415 (deep feature generation model, or DFGNet) can be trained on a smaller number (e.g., 500-1000) of classifications, each associated with a linguistically distinct name.

Training of the name embedding model 415 by knowledge distillation generally involves determining which and how many layers and connections of the KDM 350 can be removed without reducing the automated acoustical segmentation performance by too much. In general, the knowledge distillation involves copying the KDM 350 as a first (largest) iteration of the name embedding model 415, running a batch of input data to produce “correct” results (i.e., assuming that any results produced by the KDM 350 in its entirety are considered to be correct), and freezing the input and output data (e.g., the input and output labels). The name embedding model 415 can be iteratively distilled. In each iteration, the frozen input labels are provided to the distilled model, and the resulting output labels are compared to the frozen output labels to determine an amount of error that resulted from the distillation. If the error produced by the name embedding model 415 relative to the KDM 350 is within a predetermined tolerance, the name embedding model 415 can be further distilled in another iteration. If not, the previous distillation can be undone; and the name embedding model 415 can either be finalized as is (e.g., if it is sufficiently compact for the desired runtime environment), or a different type of distillation can be attempted.

In each iteration, the knowledge distillation can involve any suitable distillation task. One example of a distillation task is encoder simplification, in which the number of layers of the neural network can be reduced to make the model more lightweight. Another example of a distillation task is layer-wise distillation; rather than removing layers, knowledge can be selectively distilled from one or more layers of the teacher model to focus on only the most informative layers (e.g., and to help prevent information loss). Another example of a distillation task is reducing network connections. For example, the teacher model may have extensive inter-layer connections (e.g., skip connections between encoder and decoder layers). In such cases, in addition to reducing the numbers and/or complexity of layers, complexity can be reduced by simplifying and/or removing some of these inter-layer connections in the student model. Another example of a distillation task is downsampling, or the like. For example, the teacher model may process input streams at certain sampling rates, temporal resolutions, etc.; and those resolutions can be reduced in the student model (e.g., by downsampling, using smaller temporal step sizes, reducing the number of recurrent layers in an RNN, etc.). Similarly, precision of weight parameters can be simplified in some cases (e.g., 32-bit floating-point weights can be reduced to 8-bit weights, or lower), which can appreciably reduce computational complexity. Other examples of distillation tasks can include cases where the KDM includes complex attention mechanisms (e.g., multi-head attention in transformers), and the attention mechanism can be simplified (e.g., by reducing the number of attention heads); or if the output layer of the teacher model includes multiple output heads, and the student model may be able to operate reliably with fewer heads or a modified (simplified) structure.

Each of these or other types of distillation tasks (e.g., each distillation iteration) will potentially add some amount of error to the performance of the name embedding model 415. Such distillation error in each iteration can be evaluated in any suitable manner. In some embodiments, the name embedding model 415 is trained with a total error that is a weighted combination of the “original task error” (e.g., cross-entropy loss) and an additional “knowledge distillation error.” The knowledge distillation error measures the similarity between predictions of the KDM 350 and those of the name embedding model 415. For example, an objective function can be mathematically described as:

$$Total Error = Original Task Error + λ {\sum }_{i} Distillation {Error}_{i}$$

where λ is a hyperparameter controlling the importance (weight) of the distillation error and i is an index of a model layer.

Ultimately, the goal of training the name embedding model 415 is to distill the KDM 350 (as the teacher model) into the name embedding model 415 (as the student model) by transferring the knowledge of the KDM 350 to the name embedding model 415 in such a way that the name embedding model 415 can achieve comparable performance with appreciably reduced computational resources. It is generally assumed herein that the KDM 350 is too large and too complex to practically run in real-time within the resource confines of a WAC. For example, continuous real-time running of KDM 350 would require too many computational resources, too much memory, too much power, and/or too many other resources to be practical. As such, the goal of the knowledge distillation is to distill the knowledge of the KDM 350 into a name embedding model 415 with a size and complexity that can practically be run continuously and in real-time within the computational environment of a WAC.

As noted above, the name embedding model 415 is trained on a smaller corpus of name audio samples. Real audio samples used to train the name embedding model 415 can correspond to people's names from various regions and languages, and sample names can be chosen to cover most phonetic usage in each region. Implementations of the name embedding model 415 can be trained to recognize any suitable number of name classifications. For example, it may be impractical impossible to train the model for all possible names and their variants everywhere in the world, and a practical number of more common names (e.g., 1,000) can be chosen instead. In some implementations, different versions of the name embedding model 415 can be generated and/or trained differently for different user groupings (e.g., geographical regions, ethnicities, etc.) to capture the most popular names for the corresponding groupings. For example, grouping information can be entered by the user as part of enrollment, obtained for the user from account information, assumed for the user based on location or other demographic information, etc. Further, the name embedding model 415 can be designed with as much complex as needed to generate proper acoustical segmentations of the name classifications used for training with enough reliability to be suitable for name-detection-based attention handling. For example, a higher-complexity model (e.g., where the number of layers and/or connections is larger) may be able to more reliably discriminate among a larger number of name classifications, but use of such a model in real time will involve more computational resources (e.g., which may correspond to more processing time, more battery usage, more heat generation, etc.).

Once the name embedding model 415 has been trained (i.e., sufficiently distilled), it can be used to generate a reference embedding for each invocation name. Some embodiments of the name embedding model 415 generate an OASV 735 for each invocation name and store the OASVs 735 in the deep image 420. Some embodiments strip the output layers from the name embedding model 415, leaving only the encoding (input) and bottleneck layers, so that the output of the name embedding model 415 can be the output labels (e.g., audio tokens, or other latent space representation) of the bottleneck layer, which can be an N-dimensional vector of weights. The weights can effectively represent a highly compressed version of the input audio sample that includes only those features determined to be most salient for automated acoustical segmentation. N can be any suitable integer number to provide sufficiently reliable classification. In one implementation, N is 128. In another implementation, N is 256. For example, the name embedding model 415 generates each reference embedding as the N-dimensional vector, and stores the vectors in the deep image 420.

Some embodiments of the name embedding model 415 generate both types of reference embedding for each invocation name: both a corresponding OASV 735 from a classifier portion of the name embedding model 415 and a corresponding latent space representation from the bottleneck layer of the name embedding model 415. The deep image 420 stores both reference embeddings for each invocation name. In such embodiments, the name embedding model 415 is also configured to generate both types OASVs 735 and latent space representations for the real- time embeddings. In some implementations, the relation network 435 is trained to generate the initial identification of candidate matches using the OASVs 735 of the reference and real-time embeddings, and the false rejection network 445 is trained to discriminate true and false matches using the latent space representations of the reference and real-time embeddings.

FIGS. 10A and 10B show block diagrams 1000 of illustrative uses of the name embedding model 415 to generate the deep image 420. Turning first to FIG. 10A, a user 1005 provides a set of M invocation names 1010 via an enrollment application 330 (M is a positive integer). For example, the user 1005 speaks each name one or more times, types each name using its proper spelling, types each name phonetically, etc. The M invocation names 1010 are passed to the name embedding model 415, which generates M corresponding reference embeddings. As noted above, each reference embedding is an N-dimensional vector corresponding to a set of N weights in the name embedding model 415 that represents the invocation name that yielded that reference embedding. The name embedding model 415 generates each reference embedding as the N-dimensional vector and stores the vectors in the deep image 420, such that the deep image 420 stores M N-dimensional vectors, a single M-by-N-dimensional matrix, or the like.

Turning to FIG. 10B, a user 1005 again provides a set of M invocation names 1010 via an enrollment application 330 (M is a positive integer). Unlike in FIG. 10A, the M invocation names 1010 are passed to a name augmenter 1020, which augments the user-provided set of invocation names 1010 to generate an augmented set of invocation names 1010′. The name augmenter 1020 can include, or be in communication with, an augmentation model 1015. Embodiments of the augmentation model 1015 include mathematical transformations to apply to each of some or all of the invocation names 1010. The name augmenter 1020 can generate G augmentations (G is a positive integer) for each of the M invocation names 1010, so that the augmented set of invocation names 1010′ includes M*G names. For example, a user 1005 enrolls four invocation names, nine augmentations are applied to each invocation name to generate ten total names for each invocation name, or forty total entries in the augmented set of invocation names 1010′.

In some implementations, the name augmenter 1020 adds time-based augmentations to each of some or all of the invocation names 1010, such as by time-stretching and/or time-compressing a user-provided audio sample of the invocation name. In some implementations, the name augmenter 1020 adds accent-based augmentations to each of some or all of the invocation names 1010, such as by mathematically applying different vowel changes, regional variations, pronunciations, etc. to the invocation name. In some implementations, the name augmenter 1020 adds suprasegmental augmentations to each of some or all of the invocation names 1010, such as by mathematically applying different syllable accenting, intonation, volume, pitch, etc. Other augmentations can account for differences across genders, ages, etc. Other augmentations can account for noise models, such as models of ambient background noise, television or music noise, traffic noise, road noise, engine noise, air conditioning noise, running water noise, etc. The M*G invocation names 1010′ are passed to the name embedding model 415, which generates M*G corresponding reference embeddings. For example, the name embedding model 415 generates each reference embedding as an N-dimensional vector for storage in the deep image 420 (e.g., as M*G N-dimensional vectors, as a (M*G)-by-N-dimensional matrix, or the like). In some implementations, the name augmenter 1020 applies different augmentations to different invocation names, and/or different numbers of augmentations to different invocation names. As one example, different augmentations can be applied based on whether the invocation name is characterized more by its vowel content, or more by its consonant content. As another example, a more common term enrolled as an invocation name (e.g., “boss,” “mom”), or a shorter name enrolled as an invocation name (e.g., “Max,” “Tim”) may be augmented differently than less common terms, longer names, etc.

Returning to FIG. 4, the relation network 435 is trained with the linear and non-linear features that characterize the name embedding model 415. Embodiments of the relation network 435 are trained to output a similarity score (e.g., a probability of a match) responsive to two inputs: one of the reference embeddings from the deep image 420, and a real-time embedding generated from a real-time audio sample received via the reference microphone. For example, the one of the reference embeddings from the deep image 420 is a N-dimensional vector previously generated by the name embedding model 415 during enrollment, and the real-time embedding is an N-dimensional vector generated by the name embedding model 415 in real-time. As described above, the reference embedding vector essentially represents salient linear and non-linear features for proper acoustical segmentation, and the real-time embedding vector essentially represents the same salient linear and non-linear features of the real-time audio sample. The relation network can map those same linear and non-linear features between real-time embeddings and reference embeddings to find candidate matches. For example, in a scenario where 40 classifications are generated (i.e., the deep image 420 is a 40-by-N matrix), the relation network 435 can compute a correspondence between the real-time embedding and each of the 40 reference embeddings. This can be performed as 40 serial computations (e.g., iterative), 40 parallel computations, or in any suitable manner. Some embodiments of the relation network 435 are implemented as a two-dimensional convolutional neural network (CNN). Some other embodiments of the relation network 435 are implemented as a one-dimensional CNN, a time-delay neural network (TDNN), or another suitable neural network. Some other embodiments of the relation network 435 are implemented using simple cosine similarity or Euclidean distance estimation. For example, thresholding is performed based on the measured metric, and either a high value of the cosine similarity score represents a high relationship (for simple cosine similarity), or a minimum score represents a high relationship (for Euclidean distance).

Embodiments compute a similarity score (e.g., a mathematical correlation) between a present real-time embedding (RTE) and each of the reference embeddings and determine whether the similarity score exceeds a predetermined matching threshold (e.g., 0.3) for any one or more of the reference embeddings. If none of the reference embeddings yields a similarity score exceeding the predetermined matching threshold, embodiments determine that there is no name match and ignore the analyzed portion of the real-time audio signal (i.e., discards the RTE). If one of the reference embeddings yields a similarity score exceeding the predetermined matching threshold, the class associated with that reference embodiment is selected as a candidate matching name (i.e., that reference embedding is selected as the candidate matching reference embedding, or CMRE). If multiple reference embeddings yield similarity scores exceeding the predetermined matching threshold, the reference embedding associated with the highest similarity score is selected as the CMRE.

Embodiments of the relation network 435 are trained to output a similarity score (e.g., a probability of a match) responsive to two inputs: one of the reference embeddings from the deep image, and a real-time embedding generated from a real-time audio sample received via the reference microphone. During training of the relation network 435, a training audio sample can be used as the real-time audio sample, which is fed into the name embedding model 415 to generate a training embedding (corresponding to the real-time embedding generated during normal operation). For example, the reference embedding for a particular invoked name classification is input to the relation network 435, and a training embedding is generated by the name embedding model 415 for a training audio sample: if the training audio sample is known to correspond to a particular invocation name, the relation network 435 is trained to output ‘1’, ‘100 percent’, etc. when fed the corresponding reference and training embeddings; if the training audio sample is known not to correspond to a particular invocation name, the relation network 435 is trained to output ‘0’, ‘0 percent’, etc. when fed the corresponding reference and training embeddings. In some embodiments, the relation network 435 is trained based on the same corpus of audio samples (or a portion thereof) used to train the KDM 350. In other embodiments, the relation network 435 is trained based on the same corpus of audio samples (or a portion thereof) used to train the name embedding model 415.

The false rejection network (FRNet) 445 seeks to determine whether the CMRE and the RTE can be discriminated. In effect, the relation network 435 seeks to find a candidate match, and the false rejection network 445 seeks to determine whether the candidate match is a false match. Embodiments of the false rejection network 445 apply multiple mathematical transformations (e.g., rotations), each transformation designed to transform both the CMRE and the RTE into a corresponding domain and/or space to see whether the two datasets continue to match. For example, suppose a user has enrolled the invocation name, “Jonathan,” and the real-time audio signal includes the phrase “on a thin.” In such a scenario, the relation network 435 may find a candidate match (i.e., a similarity score exceeding the threshold), but the false rejection network 445 may determine that the candidate match is likely not a match and can be rejected. Some embodiments of the false rejection network 445 are implemented as a progressive layered extraction (PLE) neural network. Some other embodiments of the false rejection network 445 are implemented as a probabilistic linear discriminant analysis (PLDA) network.

Embodiments of the false rejection network 445 are trained to output a discrimination score (e.g., a likelihood ratio representing probability of a false match) responsive to two inputs: one of the reference embeddings from the deep image 420, and a real-time embedding generated from a real-time audio sample received via the reference microphone. The training of the false rejection network 445 can be similar to the training of the relation network 435. For example, during training of the false rejection network 445, a training audio sample can be used as the real-time audio sample, which is fed into the name embedding model 415 to generate a training embedding (corresponding to the real-time embedding generated during normal operation). Unlike the relation network 435, the false rejection network 445 is trained to apply transformations to the two inputs to look for a particular domain or space in which the two can be discriminated. For example, the training can use some training audio samples that are similar to a particular invoked name classification and other audio samples that are completely different (e.g., effectively linguistically orthogonal) to the invoked name classification. The false rejection network 445 is trained to find transformations that reliably discriminate involved name classifications from audio samples that sound like those invoked names but actually carry a different linguistic meaning. In some embodiments, the false rejection network 445 is trained based on the same corpus of audio samples (or a portion thereof) used to train the KDM 350. In other embodiments, the false rejection network 445 is trained based on the same corpus of audio samples (or a portion thereof) used to train the name embedding model 415.

The name embedding model 415, the relation network 435, and the false rejection network 445 can all be trained together (e.g., in parallel, or serially). As noted above, the name embedding model 415 is trained by knowledge distillation from the KDM 350 using a corpus of real-world name data. The input is an audio sample, and the output (after removing the output layers) is an N-dimensional weighting vector. The specific invocation names (e.g., including augmentations) are used to generate reference embeddings for each of a set of invocation name classifications, which are stored as the deep image 420. Embodiments of the relation network 435 are trained to output a respective similarity score between a real-time embedding generated from a real-time audio sample received via the reference microphone and each of the reference embeddings from the deep image 420. Embodiments of the false rejection network 445 are trained to output a respective discrimination score between a real-time embedding generated from a real-time audio sample received via the reference microphone and each of the reference embeddings from the deep image 420. Because the relation network 435 only computes similarity scores and matches them to a threshold, the relation network 435 can be very lightweight (e.g., resource-efficient). For example, even in the context of a small processor and a small battery, such as in an earbud), the relation network 435 can run continuously without using excessively processor computation cycles, without draining excessive power, without generating excessive heat, etc. Embodiments of the false rejection network 445, which may use appreciably more resources to perform transformations, etc., only run when a candidate match has been identified. Alternative embodiments can combine the functionality of the relation network 435 and the false rejection network 445, such as in contexts where resources are not as limited (e.g., implemented in over-ear headphones that include wired power).

As described above, some or all of the name embedding model 415, the relation network 435, the false rejection network 445, and the deep image 420 can be treated as a single inference model (or a “name detection model”). For example, the KDM 350 is a common model that is computed in and/or stored in the cloud 340. When invocation names are first enrolled, an enrollment application 330 is downloaded to a user device. For example, the application is downloaded to the user's laptop computer, tablet computer, smartphone, smart watch, portable audio player, headset, etc. In some implementations, the WAC 310 is associated with a case, such as for storage and/or charging; and the enrollment application 330 can be downloaded to a computational environment stored in the case.

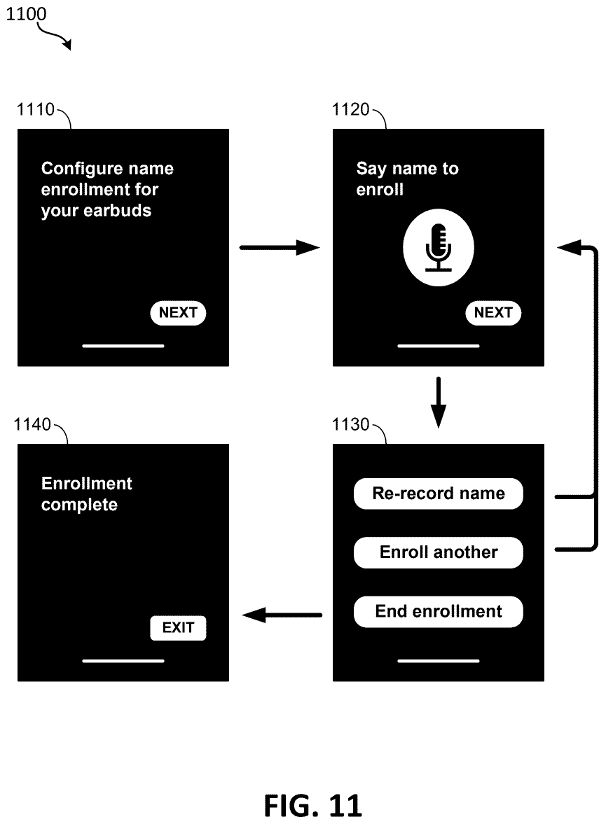

For the sake of illustration, FIG. 11 shows several example screenshots from an example enrollment application 330 running on a user device. At a first screen 1110, the user begins a name enrollment process. By clicking “NEXT” using a user interface of the user device (e.g., a touchscreen), the user can proceed to a second screen 1120. At the second screen 1120, the user is prompted to enroll an invocation name. For example, the second screen 1120 includes a button to activate a microphone of the user device by which to receive an audio sample from the user representing the invocation name being enrolled. Additionally or alternatively, the second screen 1120 (or another screen) can include interface elements for receiving text, etc. Proceeding to a third screen 1130 (e.g., by clicking “NEXT”), the user is presented with several options, such as an option to re-record the enrollment name, to enroll another name, or to end the enrollment process. Some implementations can present additional options, such as permitting the user to select any previously enrolled name to re-record, to delete, etc. In some cases, opting to re-record or to enroll another name can bring the user back to the second screen 1120, or another similar screen. Opting to end the enrollment can bring the user to a fourth screen 1140, which indicates to the user that the enrollment is complete.

In some implementations, conclusion of the user enrollment of invocation names automatically triggers the enrollment application 330 to compute (generate) some or all of the name detection model. In other implementations, subsequent to the user enrollment of invocation names, the user is prompted to continue with generation of some or all of the name detection model. In some implementations, some or all of the name detection model is generated separately from the enrollment application 330. After the name detection model is generated, the name detection model can be ported to the WAC 310 for local execution. Some embodiments of the enrollment application 330 permit the user, at any suitable time, to enroll additional invocation names, delete enrolled invocation names, etc.

Some embodiments described herein assume joint participation of a cloud-based computational platform, a local computational platform separate from the WAC 310 (e.g., a smartphone), and the computational platform integrated in the WAC 310. Different arrangements of features, components, etc. can be implemented depending on the computing, power, storage, and/or other resources of these computational platforms. In one implementation, the application is downloaded directly to the WAC 310 (or is previously loaded to the WAC 310), and the name detection model is computed directly by the WAC 310 (i.e., there is no need for a separate computational platform. In another implementation, enrollment information is exchanged with cloud-based processing resources to generate some or all of the name detection model. For example, audio samples corresponding to the invocation names (e.g., including augmentations thereof) are sent to the cloud, cloud-based resources are used to compute the name detection model, and the name detection model is ported (e.g., directly from the cloud, or via one or more intermediary devices) to the WAC 310. In other implementations, the application is directly ported to the WAC 310, and it is then downloaded to, or installed on, the local computational platform separate from the WAC 310 (e.g., the smartphone, etc.), if the local computational platform does not already have it while pairing.

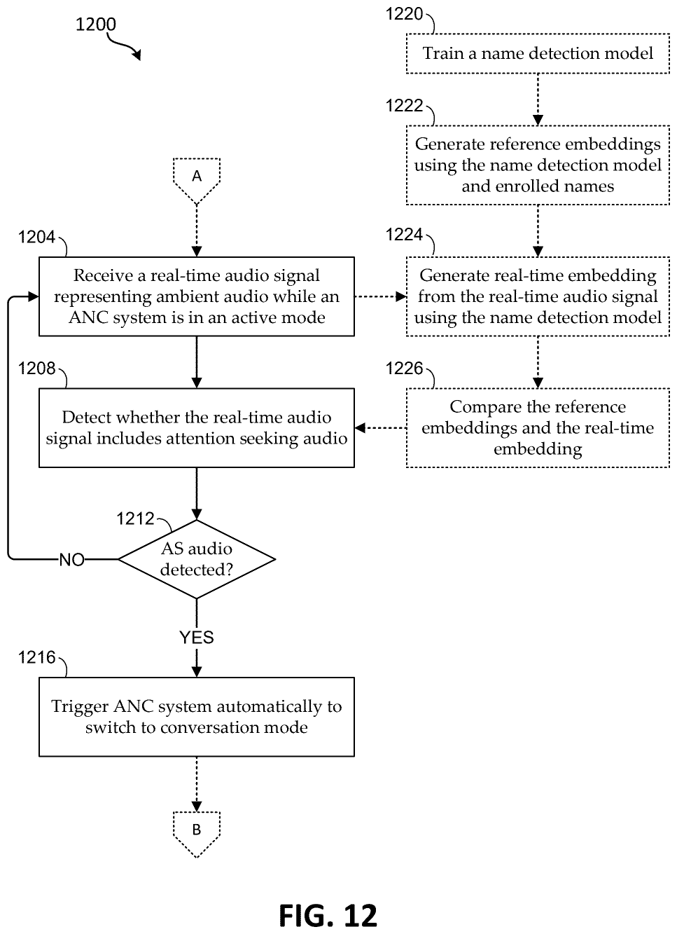

FIG. 12 shows a flow diagram of an illustrative method 1200 for audio management that includes automated attention handling in a wearable audio component (WAC), according to embodiments described herein. Embodiments of the method 1200 can be implemented using any of the system implementations described herein, or any other suitable variation thereof. Some embodiments begin at stage 1204 by receiving a real-time audio signal (e.g., from a reference microphone associated with an active noise control (ANC) system). The real-time audio signal is ambient audio received via the WAC while a user is listening to desired audio with ANC in an active (ambient sound suppression) mode.

At stage 1208, embodiments can detect whether the real-time audio signal includes attention seeking (AS) audio. For example, as described above with reference to FIG. 1, an AHS system 150 can be used to detect when a second-party attention seeker is trying to get the attention of a user while the user is wearing the WAC and is listening to desired audio 165 with the ANC system 140 in the active mode. In particular, the AHS system 150 listens for presence of attention seeking (AS) audio 157 within the ambient audio 155. For example, embodiments of the AHS system 150 are configured to listen for AS audio 157 corresponding to a previously enrolled invocation name (e.g., a name of the user). As described herein, the detection in stage 1208 can be performed using automated attention handling based on automated acoustic segmentation. As illustrated, the detection at stage 1208 can rely on prior training of a name detection (i.e., inference) model at stage 1220, generation and storage of reference embeddings based on a set of enrolled invocation names using the name detection model at stage 1222, generation of real-time embeddings from the real-time audio signal using the name detection model at stage 1224, and comparison of the real-time embeddings with the reference embeddings to determine whether the AS audio is present at stage 1226.

A determination block at stage 1212 represents the result of the determination at stage 1208. If no AS audio is detected, embodiments of the method 1200 return to stage 1204. For example, embodiments continue to listen to the real-time audio signal, and the ANC system remains in active mode. If AS audio is detected, embodiments proceed to stage 1216 by triggering the ANC system automatically to switch to a conversation mode. For example, referring back to FIG. 1, when the AS audio 157 is detected by the AHS system 150, the AHS system 150 automatically directs the ANC system 140 to switch from the active mode to the conversation mode. As described herein, the conversation mode can include disabling ANC, lowering the volume of desired audio, pausing the desired audio, enhancing conversationally relevant audio, suppressing feedback of the user's own speech, etc.

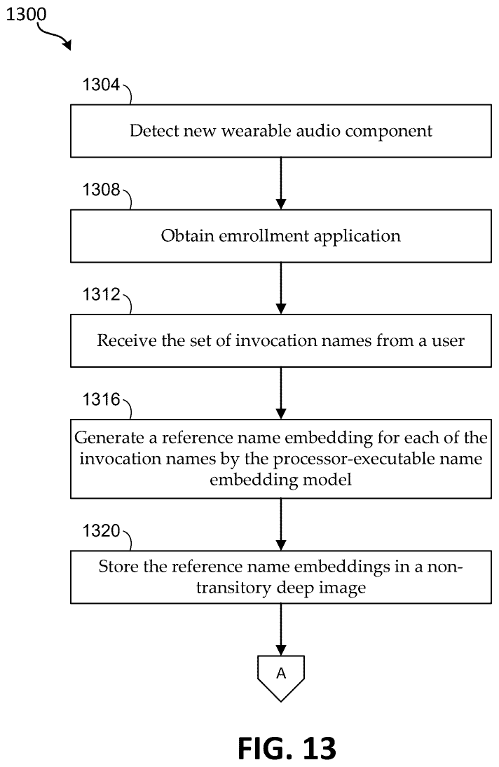

As illustrated by off-page reference “A”, some embodiments of the method 1200 include an enrollment phase prior to stage 1204. FIG. 13 shows a flow diagram of an illustrative method 1300 for such an enrollment phase. In some embodiments, the method 1300 begins at stage 1304 when a new WAC is detected. Such a detection can occur when a WAC is first paired with a user device, first paired with a network, first set to perform automated acoustical segmentation, etc. For example, the term “new” in this context can simply indicate that the WAC is new with respect to features of automated attention handling described herein. In response to the detection at stage 1304, embodiments can obtain an enrollment application (e.g., from the cloud) at stage 1308.

At stage 1312, embodiments can receive a set of invocation names (e.g., see stage 1212 of FIG. 12) from the user. At stage 1316, embodiments can generate a reference name embedding for each of the invocation names by the processor-executable name embedding model. Stage 1316 can correspond to stage 1222 of FIG. 12. In some embodiments, generating the reference name embedding at stage 1316 includes applying a plurality of augmentation transformations to each of the set of invocation names to generate an augmented set of invocation names and generating a reference name embedding for each of the augmented set of invocation names by the processor-executable name embedding model. At stage 1320, embodiments can store the reference name embeddings in a non-transitory deep image.

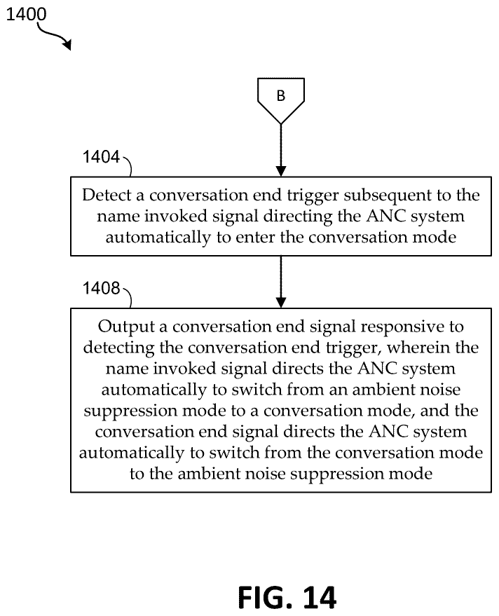

Returning to FIG. 12, embodiments of the method 1300 can also include conversation end detection subsequent to stage 1216, as indicated by off-page reference “B.” FIG. 14 shows a flow diagram of an illustrative method 1400 for such conversation end detection. For example, it is assumed that the output of the name invoked signal at stage 1216 of FIG. 12 indicates the beginning of a conversation involving the user and a second party. At stage 1404, embodiments detect a conversation end trigger subsequent to stage 1216 (i.e., after the name invoked signal directed the ANC system automatically to enter the conversation mode). At stage 1408, in response to the detection at stage 1404, embodiments can output a conversation end signal responsive to detecting the conversation end trigger. The name invoked signal directs the ANC system automatically to switch from an ambient sound suppression mode to a conversation mode, and the conversation end signal directs the ANC system automatically to switch from the conversation mode to the ambient sound suppression mode.

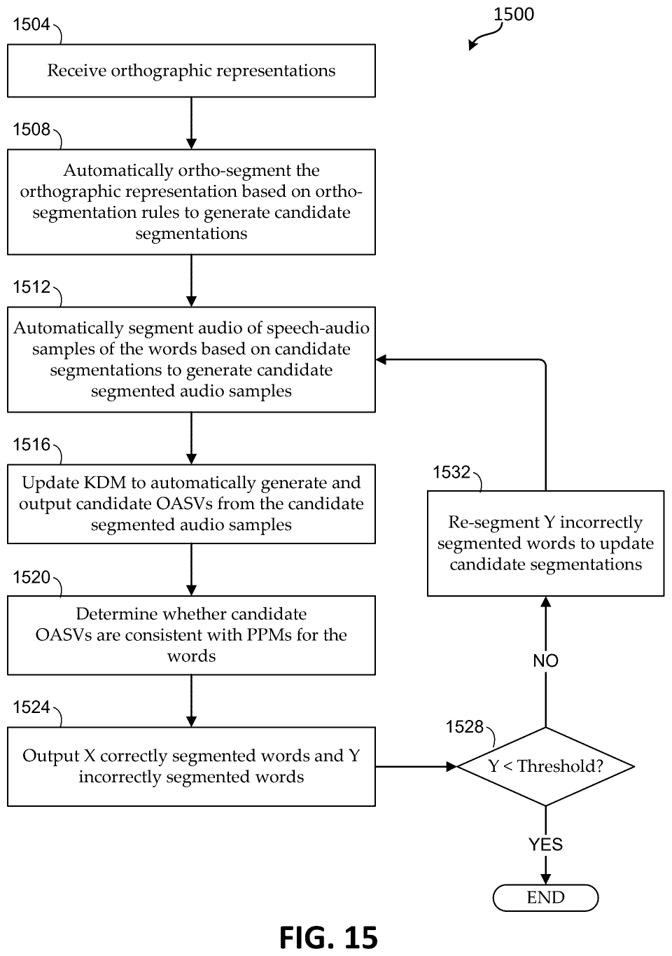

FIG. 15 shows a flow diagram of an illustrative method 1500 for training an automated acoustic segmentation (AAS) system for use with embodiments described herein. Embodiments of the method 1500 can be performed using an AAS system, such as the system of FIG. 7. Embodiments begin at stage 1504 by receiving an orthographic representation of each of a large number of words. As described above, the words can be received from a spoken word audio repository having stored thereon one or more speech-audio corpuses of suprasegmentally diversified speech-audio samples of phonetically diversified words. Each word of the phonetically diversified words is associated with multiple spoken audio samples including those of the suprasegmentally diversified speech-audio samples representing respective instances of the word. The orthographic representation is the written form of the word. There may be only one written form associated with each word (i.e., the class text). In some cases, the orthographic representation is received from the repository. In other cases, the orthographic representation is generated by a speech-to-text engine, or in any other suitable manner.

At stage 1508, embodiments can automatically ortho-segment the orthographic representations of each word based on pre-stored ortho-segmentation rules to generate a respective candidate segmentation for each word. At stage 1512, embodiments can automatically segment audio of each of the speech-audio samples for a word based on the candidate segmentation of the word, thereby generating a large number of candidate segmented audio samples for the word. At stage 1516, embodiments can update training of a knowledge distillation model (KDM) automatically to generate and output, for each word, a candidate ordered acoustical segmentation vector (OASV) based on automatically identifying salient features of the candidate segmented audio samples. As described herein, elements of the candidate OASVs map to an index matrix having cells corresponding to a predefined set of representative acoustical segments for a spoken language. At stage 1520, embodiments can automatically determine whether the candidate OASV output by the KDM for each word is consistent with a posterior probability matrix (PPM) for the word. The PPMs have cells corresponding to those of the index matrix. Based on the determination, at stage 1524, embodiments can output a set of X correctly segmented words for which the candidate OASV is determined to be consistent with the PPM for the word, and a set of Y incorrectly segmented words for which the candidate OASV is determined to be inconsistent with the PPM for the word, X and Y being positive integers.

A determination is made at stage 1528 as to whether Y is below a predetermined threshold (i.e., whether at least a threshold number of words can be correctly acoustically segmented). If not, at stage 1532, embodiments can re-segment at least the Y incorrectly segmented words to generate updated candidate segmentations. In some implementations, the re- segmentation at stage 1532 is manual in some or all iterations. In other implementations, the re- segmentation at stage 1532 is automatic, or partially automatic, in some or all iterations. Embodiments can then iterate back through stages 1512-1528 with the updated candidate segmentations. In some implementations, in each iteration, only the re-segmented words are run back through stages 1512-1528. In other implementations, all words are run back through stages 1512-1528. For example, any of the X correctly segmented words from a prior iteration are passed back through with the same segmentation used in that prior iteration. As described herein, the first pass through stages 1504-1528 can be referred to as a first training phase (or sub-phase), and subsequent passes through stages 1532 and 1512-1528 can be referred to as a second training phase (or sub-phase). After one or more iterations, Y will be determined at stage 1528 to fall below the threshold, and the method 1500 can end. For example, at that point, the KDM can be frozen and used for knowledge distillation-based training of the inference model (e.g., the name embedding model).

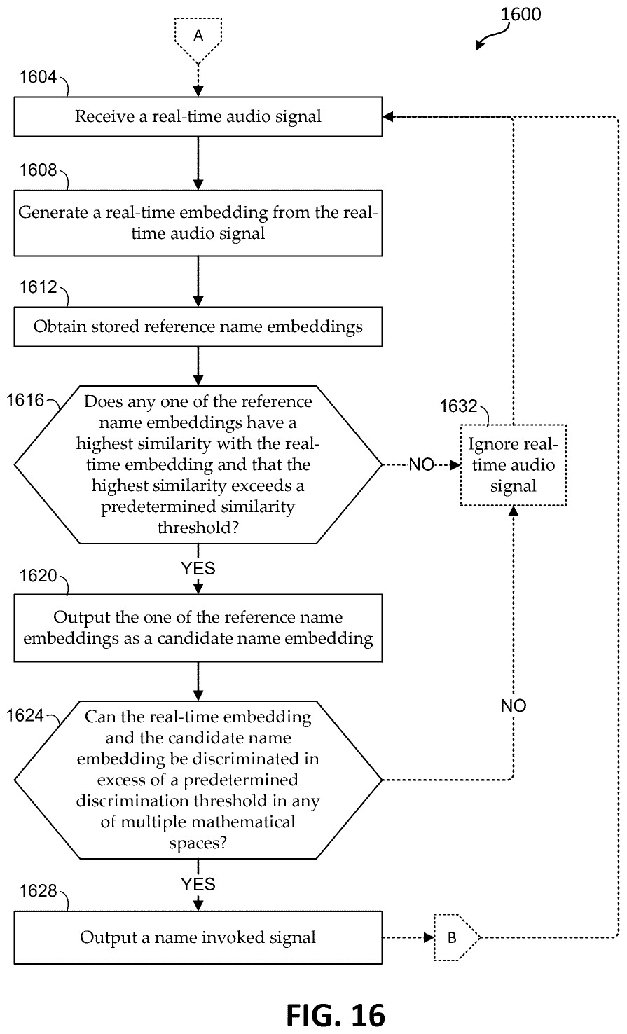

FIG. 16 shows a flow diagram of an illustrative method 1600 for automated acoustic segmentation-based attention handling in a wearable audio component (WAC), according to embodiments described herein. Embodiments can begin during runtime operation of an active noise control (ANC) system of the WAC, while a user is wearing the WAC and the ANC system is operating in an ambient sound suppression mode. Such embodiments can begin at stage 1604 by receiving a real-time audio signal. At stage 1608, embodiments can generate a real-time embedding from the real-time audio signal by a name embedding model trained automatically to acoustically segment a corpus of real-world name audio samples in accordance with a predefined set of representative acoustical segments for a spoken language. In some embodiments, the name embedding model is trained further by knowledge distillation from a knowledge distillation model (KDM). The KDM is an artificial neural network trained (e.g., according to the method 1500 of FIG. 15) automatically to acoustically segment a speech-audio corpus of phonetically diversified words spoken by a plurality of accent-diversified speakers in accordance with the predefined set of representative acoustical segments.

At stage 1612, embodiments can obtain a stored number of reference name embeddings previously generated by the name embedding model based on a set of invocation names provided by a user during an enrollment procedure. At stage 1616, embodiments can determine (e.g., by a pre-trained relation network) whether any one of the reference name embeddings has a highest similarity with the real-time embedding and that the highest similarity exceeds a predetermined similarity threshold. If not, at stage 1632, embodiments can ignore the real-time audio signal and can return to stage 1604 to receive a next real-time audio signal.

At stage 1620, embodiments can output the one of the reference name embeddings as a candidate name embedding responsive to determining at stage 1616 that one of the reference name embeddings has the highest similarity with the real-time embedding and that the highest similarity exceeds the predetermined similarity threshold. At stage 1624, embodiments can determine (e.g., by a pre-trained false rejection network), responsive to the outputting at stage 1620, whether the real-time embedding and the candidate name embedding can be discriminated in excess of a predetermined discrimination threshold in any of several mathematical spaces. If not, at stage 1632, embodiments can ignore the real-time audio signal and can return to stage 1604 to receive a next real-time audio signal. If so (i.e., responsive to determining that the real-time embedding and the candidate name embedding cannot be discriminated in excess of the predetermined discrimination threshold in any of several mathematical spaces), at stage 1628, embodiments can output a name invoked signal, which directs the ANC system automatically switch from the ambient sound suppression mode to a conversation mode.

In some embodiments, generating the real-time embeddings at stage 1608 includes generating a real-time bottleneck feature embedding (BFE) by a bottleneck layer of the name embedding model and generating a real-time ordered acoustical segmentation vector (OASV) by one or more output layers of the name embedding model. In such embodiments, each of the stored plurality of reference name embeddings is also previously generated by the name embedding model to include a reference BFE and a reference OASV. In some such embodiments, the determining at stage 1616 includes determining whether one of the reference OASVs has a highest similarity with the real-time OASV, the one of the reference OASVs being the respective reference OASV of the candidate name embedding. In some such embodiments, the determining at stage 1624 includes determining whether the real-time BFE and the respective reference BFE of the candidate name embedding cannot be discriminated in excess of the predetermined discrimination threshold. In some implementations, each reference BFE and the real-time BFE is generated by the name embedding model as a latent space representation vector and/or as a set of audio tokens. In some implementations, each reference OASV and the real-time OASV are generated by the name embedding model as a 1-by-L vector of index values, each index value either indicating an unused element of the OASV, or pointing to a cell of a J-by-K index matrix, each cell of the J-by-K index matrix corresponding to a respective one of the predefined set of representative acoustical segments.

Referring back to the method 1200 of FIG. 12, the AAS-based approach described in FIG. 16 can be used for automated attention handling. For example, stage 1604 of FIG. 16 can be an implementation of stage 1204 of FIG. 12, in which a real-time audio signal is received by a reference microphone associated with an active noise control (ANC) system while the ANC system is in an ambient sound suppression mode. It can be assumed that the ANC system is integrated into a wearable audio component being worn by a first party (e.g., the user). Stages 1608-1624 of FIG. 16 can be an implementation of stages 1208 and 1212 of FIG. 12, in which a pre-trained inference model is used to detect whether the real-time audio signal includes attention-seeking audio spoken by a second party (i.e., the attention seeker, who is someone other than the user). The attention-seeking audio is predetermined to indicate that the second party is seeking attention of the first party. Stage 1628 of FIG. 16 can be an implementation of stage 1216 of FIG. 12, in which a name invoked signal is output to the ANC system automatically in response to determining that the real-time audio signal includes the attention-seeking audio, the name invoked signal directing the ANC system automatically to switch from the ambient sound suppression mode to a conversation mode. As illustrated in FIG. 16 and described in the context of FIG. 12, some embodiments can further include enrollment (e.g., according to the method 1300 of FIG. 13) and/or detection of a conversation end trigger (e.g., according to the method 1400 of FIG. 14).

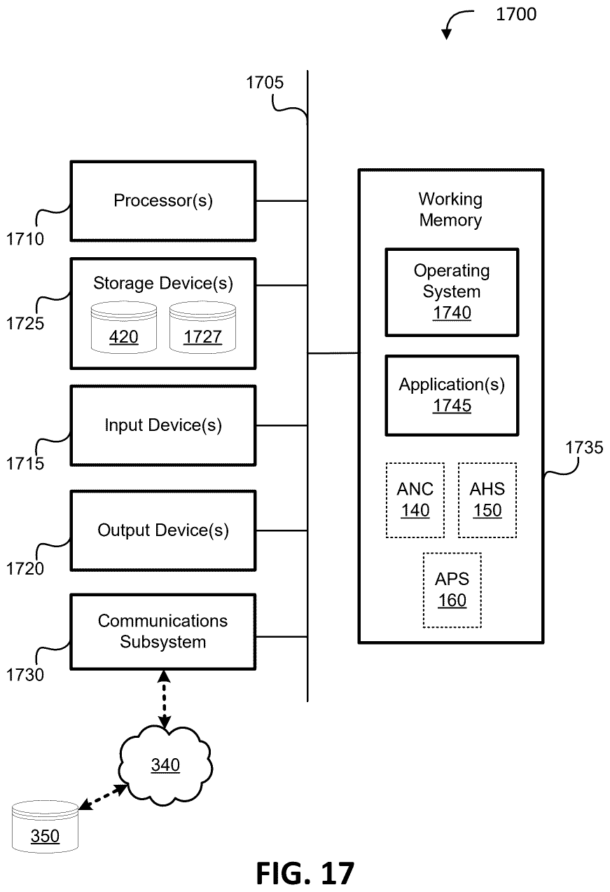

FIG. 17 provides a schematic illustration of an illustrative computational system 1700 that can implement various system components and/or perform various steps of methods provided by various embodiments. Embodiments of the computational system 1700 can be integrated in a WAC, such as an earbud, headset, etc. Embodiments of the computational system 1700 can implement some or all of the audio management system 100 of FIG. 1, including embodiments of the AHS 150, the ANC 140, and/or the audio processing system (APS) 160 described herein. FIG. 17 is meant only to provide a generalized illustration of various components, any or all of which may be utilized as appropriate. FIG. 17, therefore, broadly illustrates how individual system elements may be implemented in a relatively separated or relatively more integrated manner.

The computational system 1700 is shown including hardware elements that can be electrically coupled via a bus 1705 (or may otherwise be in communication, as appropriate). The hardware elements may include one or more processors 1710, including, without limitation, one or more general-purpose processors and/or one or more special-purpose processors (such as digital signal processing chips, graphics acceleration processors, video decoders, and/or the like); one or more input devices 1715; and one or more output devices 1720. In the WAC context, the input devices 1715 can include wired and/or wireless ports, buttons, switches, microphones, touch interfaces, and/or any other suitable input device 1715; and the output devices 1720 can include indicator lights, displays, speakers, and/or any other suitable output devices 1720.

The computational system 1700 may further include (and/or be in communication with) one or more non-transitory storage devices 1725, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable and/or the like. Such storage devices may be configured to implement any appropriate data stores, including, without limitation, various file systems, database structures, and/or the like. In some embodiments, the storage devices 1725 include the deep image 420 and/or an inference model 1727. As described herein, the inference model can include one or more types of name embedding models, relation networks, false rejection networks, etc. for implementing name detection-based attention handling.

The computational system 1700 can also include a communications subsystem 1730, which can include, without limitation, a modem, a network card (wireless or wired), an infrared communication device, a wireless communication device, and/or a chipset (such as a Bluetooth™ device, an 802.11 device, a Wi-Fi device, a WiMAX device, cellular communication device, etc.), and/or the like. As described herein, the communications subsystem 1730 supports multiple communication technologies. Further, as described herein, the communications subsystem 1730 can provide communications with one or more networks 140, and/or other networks. For example, embodiments of the communications subsystem 1730 can communicate with a KDM 350 via the cloud 350. Though not explicitly shown, some embodiments interface via the communications subsystem 1730, and/or via input devices 1715 and output devices 1720, with one or more user computational devices 320.

In many embodiments, the computational system 1700 will further include a working memory 1735, which can include a RAM or ROM device, as described herein. The computational system 1700 also can include software elements, shown as currently being located within the working memory 1735, including an operating system 1740, device drivers, executable libraries, and/or other code, such as one or more application programs 1745, which may include computer programs provided by various embodiments, and/or may be designed to implement methods, and/or configure systems, provided by other embodiments, as described herein. Merely by way of example, one or more procedures described with respect to the method(s) discussed herein can be implemented as code and/or instructions executable by a computer (and/or a processor within a computer); in an aspect, then, such code and/or instructions can be used to configure and/or adapt a general-purpose computer (or other device) to perform one or more operations in accordance with the described methods. In some embodiments, the operating system 1740 and the working memory 1735 are used in conjunction with the one or more processors 1710 to implement some or all of the audio management system 100 components, such as the ANC 140, AHS 150, and/or APS 160.

A set of these instructions and/or codes can be stored on a non-transitory computer-readable storage medium, such as the non-transitory storage device(s) 1725 described above. In some cases, the storage medium can be incorporated within a computer system, such as computer system 1700. In other embodiments, the storage medium can be separate from a computer system (e.g., a removable medium, such as a compact disc), and/or provided in an installation package, such that the storage medium can be used to program, configure, and/or adapt a general-purpose computer with the instructions/code stored thereon. These instructions can take the form of executable code, which is executable by the computational system 1700 and/or can take the form of source and/or installable code, which, upon compilation and/or installation on the computational system 1700 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware can also be used, and/or particular elements can be implemented in hardware, software (including portable software, such as applets, etc.), or both. Further, connection to other computing devices, such as network input/output devices, may be employed.

As mentioned above, in one aspect, some embodiments may employ a computer system (such as the computer system 1700) to perform methods in accordance with various embodiments of the invention. According to a set of embodiments, some or all of the procedures of such methods are performed by the computational system 1700 in response to processor 1710 executing one or more sequences of one or more instructions (which can be incorporated into the operating system 1740 and/or other code, such as an application program 1745) contained in the working memory 1735. Such instructions may be read into the working memory 1735 from another computer-readable medium, such as one or more of the non-transitory storage device(s) 1725. Merely by way of example, execution of the sequences of instructions contained in the working memory 1735 can cause the processor(s) 1710 to perform one or more procedures of the methods described herein.

The terms “machine-readable medium,” “computer-readable storage medium” and “computer-readable medium,” as used herein, refer to any medium that participates in providing data that causes a machine to operate in a specific fashion. These mediums may be non-transitory. In an embodiment implemented using the computer system 1700, various computer-readable media can be involved in providing instructions/code to processor(s) 1710 for execution and/or can be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 1725. Volatile media include, without limitation, dynamic memory, such as the working memory 1735. Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 1710 for execution. Merely by way of example, the instructions may initially be carried on a magnetic disk and/or optical disc of a remote computer. A remote computer can load the instructions into its dynamic memory and send the instructions as signals over a transmission medium to be received and/or executed by the computer system 1700. The communications subsystem 1730 (and/or components thereof) generally will receive signals, and the bus 1705 then can carry the signals (and/or the data, instructions, etc., carried by the signals) to the working memory 1735, from which the processor(s) 1710 retrieves and executes the instructions. The instructions received by the working memory 1735 may optionally be stored on a non-transitory storage device 1725 either before or after execution by the processor(s) 1710.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. An audio management system for integration in a wearable audio component, the audio management system comprising:
an automated acoustic segmentation attention handling system (AAS-AHS) comprising:
a processor-executable name embedding model to generate an output embedding from an audio sample, the name embedding model trained automatically to acoustically segment a corpus of real-world name audio samples in accordance with a predefined set of representative acoustical segments for a spoken language;
a processor-readable deep image comprising reference name embeddings generated by the name embedding model based on a set of invocation names provided by a user during an enrollment procedure;
a processor-executable relation network coupled with the deep image and the name embedding model to output a candidate name embedding responsive to determining that one of the reference name embeddings has a highest similarity with a real-time embedding generated by the name embedding model from a real-time audio signal received from a reference microphone associated with an active noise control (ANC) system and that the highest similarity exceeds a predetermined similarity threshold, the candidate name embedding being the one of the reference name embeddings; and
a processor-executable false rejection network coupled with the relation network to output a name invoked signal responsive to determining that the real-time embedding and the candidate name embedding cannot be discriminated in excess of a predetermined discrimination threshold in any of a plurality of mathematical spaces, the name invoked signal to direct the ANC system automatically to enter a conversation mode.

2. The audio management system of claim 1, wherein:
the name embedding model is to generate the output embedding from an audio sample, as a bottleneck feature embedding (BFE) and an ordered acoustical segmentation vector (OASV), such that each reference embedding in the deep image comprises a respective reference BFE and a respective reference OASV.

3. The audio management system of claim 2, wherein:
each real-time embedding comprises a respective real-time BFE and a respective real-time OASV generated by the name embedding model from the real-time audio signal;
the relation network is to output the candidate name embedding responsive to determining that one of the reference OASVs has a highest similarity with the real-time OASV, the one of the reference OASVs being the respective reference OASV of the candidate name embedding; and
the false rejection network is to output the name invoked signal responsive to determining that the real-time BFE and the respective reference BFE of the candidate name embedding cannot be discriminated in excess of the predetermined discrimination threshold.

4. The audio management system of claim 2, wherein:
the name embedding model is to generate the BFE as a latent space representation vector and/or as a set of audio tokens.

5. The audio management system of claim 2, wherein:
the name embedding model is to generate the OASV as a 1-by-L vector of index values, each index value either indicating an unused element of the OASV, or pointing to a cell of a J-by-K index matrix, each cell of the J-by-K index matrix corresponding to a respective one of the predefined set of representative acoustical segments.

6. The audio management system of claim 1, wherein:
the name embedding model is trained further by knowledge distillation from a knowledge distillation model (KDM), the KDM being an artificial neural network trained automatically to acoustically segment a speech-audio corpus of phonetically diversified words spoken by a plurality of accent-diversified speakers in accordance with the predefined set of representative acoustical segments.

7. The audio management system of claim 1, further comprising:
one or more processors; and
a non-transitory processor-readable storage medium having, stored thereon, the deep image and instructions which, when executed, cause the one or more processors to implement the name embedding model, the relation network, and the false rejection network.

8. The audio management system of claim 1, further comprising:
the ANC system comprising:
a reference microphone input to couple with the reference microphone;
an error microphone input to couple with an error microphone; and
an ANC-AHS interface to receive the name invoked signal from the AAS-AHS.

9. The audio management system of claim 8, wherein the AAS-AHS further comprises:
an attention seeking trigger detector having a trigger detector input coupled with the reference microphone to receive the real-time audio input and a trigger detector output coupled with the ANC-AHS interface of the ANC system to provide the name invoked signal, the attention seeking trigger detector comprising the name embedding model, the deep image, the relation network, and the false rejection network; and
a conversation end detector to output a conversation end signal responsive to detecting a conversation end trigger, the conversation end detector coupled with the ANC-AHS interface to provide the conversation end signal to the ANC system,
wherein the name invoked signal directs the ANC system automatically to switch from an ambient sound suppression mode to a conversation mode, and the conversation end signal directs the ANC system automatically to switch from the conversation mode to the ambient sound suppression mode.

10. The audio management system of claim 1, wherein the AAS-AHS further comprises:
a conversation enhancement subsystem configured, when the ANC system is in the conversation mode, to:
receive an ambient sound signal from the reference microphone;
analyze the ambient sound signal to extract and enhance a conversationally relevant portion of the ambient sound signal as conversation audio; and
output the conversation audio via an ear speaker.

11. A wearable audio component comprising the audio management system of claim 1.

12. A method for automated acoustic segmentation-based attention handling in a wearable audio component (WAC), method comprising:
during runtime operation of an active noise control (ANC) system of the WAC, while a user is wearing the WAC and the ANC system is operating in an ambient sound suppression mode:
receiving a real-time audio signal;
generating a real-time embedding from the real-time audio signal by a name embedding model trained automatically to acoustically segment a corpus of real-world name audio samples in accordance with a predefined set of representative acoustical segments for a spoken language;
obtaining a stored plurality of reference name embeddings previously generated by the name embedding model based on a set of invocation names provided by a user during an enrollment procedure;
determining, by a pre-trained relation network, whether any one of the reference name embeddings has a highest similarity with the real-time embedding and that the highest similarity exceeds a predetermined similarity threshold;
outputting the one of the reference name embeddings as a candidate name embedding responsive to determining that one of the reference name embeddings has the highest similarity with the real-time embedding and that the highest similarity exceeds the predetermined similarity threshold;
determining, by a pre-trained false rejection network, responsive to the outputting the one of the reference name embeddings as the candidate name embedding, whether the real-time embedding and the candidate name embedding can be discriminated in excess of a predetermined discrimination threshold in any of a plurality of mathematical spaces; and
outputting a name invoked signal responsive to determining that the real-time embedding and the candidate name embedding cannot be discriminated in excess of the predetermined discrimination threshold in any of a plurality of mathematical spaces, the name invoked signal to direct the ANC system automatically switch from the ambient sound suppression mode to a conversation mode.

13. The method of claim 12, further comprising:
during the enrollment procedure of the ANC system of the WAC, prior to the runtime operation:
receiving the set of invocation names from the user;
generating the plurality of reference name embeddings by the name embedding model based on the set of invocation names; and
storing the reference name embeddings in a deep image.

14. The method of claim 12, wherein the generating the real-time embedding from the real-time audio signal by the name embedding model comprises:
the generating the real-time embedding from the real-time audio signal by the name embedding model comprises:
generating a real-time bottleneck feature embedding (BFE) by a bottleneck layer of the name embedding model; and
generating a real-time ordered acoustical segmentation vector (OASV) by one or more output layers of the name embedding model; and
each of the stored plurality of reference name embeddings is previously generated by the name embedding model to include a reference BFE and a reference OASV.

15. The method of claim 14, wherein:
the determining by the pre-trained relation network comprises determining whether one of the reference OASVs has a highest similarity with the real-time OASV, the one of the reference OASVs being the respective reference OASV of the candidate name embedding; and
the determining by the pre-trained false rejection network comprises determining whether the real-time BFE and the respective reference BFE of the candidate name embedding cannot be discriminated in excess of the predetermined discrimination threshold.

16. The method of claim 14, wherein:
each reference BFE and the real-time BFE are generated by the name embedding model as a latent space representation vector and/or as a set of audio tokens.

17. The method of claim 14, wherein:
each reference OASV and the real-time OASV are generated by the name embedding model as a 1-by-L vector of index values, each index value either indicating an unused element of the OASV, or pointing to a cell of a J-by-K index matrix, each cell of the J-by-K index matrix corresponding to a respective one of the predefined set of representative acoustical segments.

18. The method of claim 12, wherein:
the name embedding model is trained further by knowledge distillation from a knowledge distillation model (KDM), the KDM being an artificial neural network trained automatically to acoustically segment a speech-audio corpus of phonetically diversified words spoken by a plurality of accent-diversified speakers in accordance with the predefined set of representative acoustical segments.

19. An automated acoustical segmentation (AAS) training system, the AAS training system comprising:
a processor-readable spoken word audio repository having stored thereon one or more speech-audio corpuses of suprasegmentally diversified speech-audio samples of phonetically diversified words, such that each word of the phonetically diversified words is associated with a plurality of spoken audio samples comprising those of the suprasegmentally diversified speech-audio samples representing respective instances of the word;
a processor-executable training auto-supervisor coupled with the spoken word audio repository and comprising:
an ortho-segmenter to, for each word, receive an orthographic representation of the word, and automatically ortho-segment the orthographic representation based on pre-stored processor-readable ortho-segmentation rules to generate a candidate segmentation for the word;
an audio segmenter to, for each word, receive the candidate segmentation for the word and the plurality of speech-audio samples for the word, and automatically segment audio of each of the plurality of speech-audio samples based on the candidate segmentation to generate a plurality of candidate segmented audio samples for the word;
a knowledge distillation model (KDM) to train a plurality of layers of a neural network automatically to generate and output, for each word, a candidate ordered acoustical segmentation vector (OASV) based on automatically identifying salient features of the plurality of candidate segmented audio samples to map to an index matrix having cells corresponding to a predefined set of representative acoustical segments for a spoken language; and
an evaluator automatically to determine whether the candidate OASV output by the KDM for each word is consistent with a posterior probability matrix (PPM) for the word, the PPM having cells corresponding to those of the index matrix, and to output a set of X correctly segmented words for which the candidate OASV is determined to be consistent with the PPM for the word, and a set of Y incorrectly segmented words for which the candidate OASV is determined to be inconsistent with the PPM for the word, X and Y being positive integers.

20. The AAS training system of claim 19, wherein:
in a first training phase:
the audio segmenter receives the candidate segmentations for all of the words from the ortho-segmenter;
in a second training phase following the first training phase, for each of one or more iterations, while Y is greater than a predetermined training threshold:
for each of the Y incorrectly segmented words, the audio segmenter receives a re-segmentation of the word as an updated candidate segmentation of the word for the iteration;
for each of the X correctly segmented words the audio segmenter uses the candidate segmentation for the word from the ortho-segmenter as the updated candidate segmentations of the word for the iteration;
the KDM generates and outputs updated candidate OASVs based on the updated candidate segmentations for the iteration; and
the evaluator updates the set of X correctly segmented words and the set of Y incorrectly segmented words based on the updated candidate OASV.
